(19) United States
(12) Patent Application Publication
(10) Pub. No.: US 2026/0028457 A1
(43) Pub. Date: Jan. 29, 2026

(54) AMINE CONTAINING COPOLYMER EMULSION COMPOSITIONS AND METHODS OF MAKING AND USE THEREOF

(71) Applicant: Infineum International Limited, Linden, NJ (US)

(72) Inventor: Evan Haidasz, Hoboken, NJ (US)

(73) Assignee: Infineum International Limited, Linden, NJ (US)

(21) Appl. No.: 19/279,027

(22) Filed: Jul. 24, 2025

Related U.S. Application Data
(60) Provisional application No. 63/675,958, filed on Jul. 26, 2024.

(51) Int. Cl. C08J 3/07; C08F 2/06; C08F 236/08; C08F 236/10

(52) U.S. Cl. CPC C08J 3/07; C08F 2/06; C08F 236/08; C08F 236/10; C08J 2309/06

(57) ABSTRACT

Provided is an aqueous based copolymer emulsion composition comprising: i) from 1 to 60 wt. % of one or more copolymers comprising: (a) one or more amine-derivatized alpha-methyl styrene (ADAMS) repeat units according to structure (I):

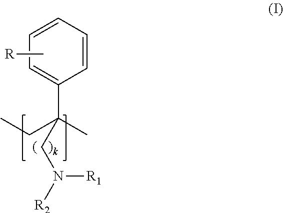

wherein k, R, R₁ and R₂ are defined herein; and (b) one or more repeat units comprising styrene, isoprene, butadiene, or combinations thereof, (ii) from 0.05 to 5.0 wt. % of one or more surfactants; and (iii) the remainder of the composition comprising water. Also provided are methods of making and using the aqueous based copolymer emulsion composition.

### CROSS-REFERENCE TO RELATED APPLICATION

This U.S. Non-provisional application claims priority to U.S. Provisional Application Ser. No. 63/675,958 filed on Jul. 26, 2024, the contents of which are herein incorporated by reference in their entirety.

### FIELD

This disclosure relates to aqueous emulsions of amine containing copolymers derived from monomer compositions containing aromatic structures each containing at least one aminic nitrogen. More particularly, this disclosure relates to amine containing copolymer emulsion compositions including one or more amine containing copolymers, one or more surfactants and water. This disclosure also relates to methods of making such emulsions and methods of using such emulsions.

### BACKGROUND

There are myriad references disclosing nitrogen-containing (amine) groups pendant to the phenyl ring in styrenic monomers/polymers/copolymers. However, monomers and polymers bearing such pendant groups can be chemically difficult to synthesize reliably/repetitively. Even when such synthesis can be accomplished, there can be issues with propagation within the polymerization reactions containing such amine-functionalized styrenic monomers, whether alone or as copolymer with other styrenic monomers.

Thus, frequently the amine group can be added to a smattering of monomer repeat units using post-polymerization chemical reactions. But post-polymerization chemistry can often come through with different issues, even if it may avoid the propagation issues of amine-functionalized styrenic monomers.

As such, it is desirable to develop an unconventional way to functionalize a styrenic monomer pre-polymerization, particularly one that was neutral to, or perhaps even enhanced, the propagation within the polymerization reaction.

U.S. Pat. Nos. 6,486,272, 9,364,825, 10,202,494, and 10,046,285, disclose polymers made from styrenic monomers bearing nitrogen-containing groups pendant to the phenyl ring, all of which are herein incorporated by reference in their entirety. GB Patent No. 1 381 755 discloses amine-functional monomer compounds, but only with acrylamide functionality. Other examples of potentially relevant publications include, but are not necessarily limited to, U.S. Pat. Nos. 7,790,661, 7,960,320, 8,778,854, and 10,414,999; and PCT Publication No. WO 2021/127183, all of which are herein incorporated by reference in their entirety.

Based on the difficulty of preparing and polymerizing styrenic monomers bearing nitrogen-containing groups pendant to the phenyl ring, Applicant has explored other potential structures for functional monomers which are both simpler to manufacture and also polymerize. These functional monomer compositions containing aromatic and/or conjugated (non-aromatic) structures each containing at least one aminic nitrogen are described in commonly owned related U.S. Provisional Application Ser. No. 63/483,365 filed on Feb. 6, 2023, the contents of which are herein incorporated by reference in their entirety.

U.S. Pat. No. 2,778,826 (“the '826 Schmidle patent”) and a 1955 article by Schmidle and Mansfield, entitled “The Aminomethylation of Olefins. I. The Reaction of Secondary Amines, Formaldehyde, and Olefins,” both disclose various reactions alleging formation of 3-aryl-3-butenyl-1-amines, in which the formaldehyde and secondary amine allegedly formed an iminium, which reacted with the styrenic olefin to form only the terminal (vinylidene) double-bond version of the amine-functional styrenic. The 1955 article also disclosed amine-functionalization of terpenoids such as α- and β-pinene, camphene, and limonene, but not isoprene or similar conjugated non-aromatic compounds.

1983 article by Cohen and Onopchenko, entitled “Competing Hydride Transfer and Ene Reactions in the Aminoalkylation of 1-Alkenes with N,N-Dimethylmethyleniminium Ions. A Literature Correction” (citing, in part, to the '826 Schmidle patent, inter alia), further disclosed a mechanistic study of specifically dimethyliminimum compounds reacting with styrenic and non-styrenic olefins. Notably, at the beginning of the Discussion section, the 1983 article opines that the '826 Schmidle patent (and presumably the 1955 article containing strikingly similar experiments and results thereto) had made mistakes. Nonetheless, with respect to aminomethylation of α-methylstyrene, the 1983 article indicated formation of vinylidene-based product, in tandem with a significant vinylene (not terminal double-bond) content and a quite significant (13%, in the case of the dimethylamino-version) saturated arylalkane-amine content.

The inventive monomers disclosed in U.S. Provisional Application Ser. No. 63/483,365 have, to the best of the Applicant's knowledge, not been previously polymerized.

Secondary metal ion batteries include both an anode and a cathode. These electrodes are typically coated with a polymer-based slurry composition that serves to form a uniform layer of active material that adheres to the current collector and retains structural integrity during the lifetime of the battery. Silicon has been extensively pioneered to be the next most important anode material used in secondary lithium-ion battery (LiB) to replace graphite due to the added high capacity (×4) and fast charging capabilities (via thinner electrode). The addition of a low level of Si (˜5%) to anode formulations have been proven to meet 3rd generation electric vehicle (EV) targets in terms of battery performance. However, at higher Si level, Si-anode materials experience high volume changes (4×) during lithiation-delithiation which leads to the following issues: (1) pulverization or cracking of Si particles; (2) delamination of functional coating from the current collector; (3) unstable solid-electrolyte interface. These problems cannot be resolved using currently available polymeric binder materials, which are predominately styrene butadiene rubber (SBR) in combination with CMC (carboxymethyl cellulose) or PAA (polyacrylic acid) as co-binders materials in the polymer based slurry for coating on the battery anode.

Hence, there is a need for improved functional polymeric binder materials based on alpha-substituted functional monomers, and in particular functional polymers based on functional monomer compositions containing aromatic structures each containing at least one aminic nitrogen for use in slurries used in coating battery electrodes to improve the overall performance of the battery in terms of life. The polymeric binders are typically introduced into the slurries as polymer emulsions in water to both aid in handleability, and the mixing process to form homogenous blends prior to coating the electrode.

There is also a need for improved aqueous emulsions of amine containing copolymers derived from monomer compositions containing aromatic structures each containing at least one aminic nitrogen for use in other applications, including, but not limited to, as a plastic additive, a drag reducing agent, a magneto-rheological fluid, an electro-chlorination additive, an industrial coating additive, an adhesive additive, an asphaltene and wax inhibitor, a refinery anti-foulant, an industrial or household surfactant, an agrochemical additive, a ceramic capacitor or indictor additive, an emulsion explosive additive, an anti-microbial coating, a crude transportation and refining additive, and a carbon-capture additive.

### SUMMARY

According to the present disclosure, provided is an advantageous aqueous based copolymer emulsion composition, comprising:
i) from 1 to 60 wt. % of one or more copolymers comprising:
   (a) one or more amine-derivatized alpha-methyl styrene (ADAMS) repeat units according to structure (I):

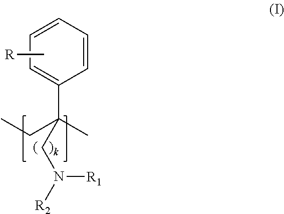

wherein:
   k is an integer from 1 to 3;
   R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof;
   R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof, and
   (b) one or more repeat units according to structures (II), (IIIₐ), (III_{b}), or combinations thereof

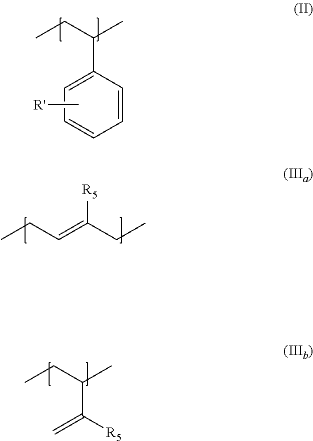

wherein:
   R₅ is a hydrogen or methyl group;
   R′ is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, and/or combinations thereof;
(ii) from 0.05 to 5.0 wt. % of one or more one or more surfactants selected from the group consisting of anionic surfactants, cationic surfactants, nonionic surfactants, amphoteric surfactants, and combinations thereof; and
(iii) the remainder of the composition comprising water.

According to the present disclosure, provided is also an aqueous based copolymer emulsion composition comprising:
i) from 1 to 60 wt. % of one or more copolymers comprising:
   (a) the reaction product of one or more monomers according to structure (VI)

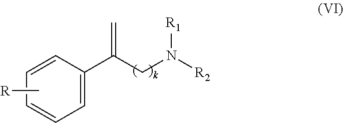

wherein:
   k is an integer from 1 to 3;
   R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof;
   R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof, and
   (b) the reaction product of one or more monomers according to structures (VII), (VIII), or combinations thereof

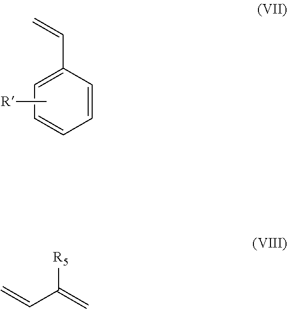

wherein:
   R₅ is a hydrogen or methyl group;
   R′ is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, and/or combinations thereof;
(ii) from 0.05 to 5.0 wt. % of one or more surfactants selected from the group consisting of anionic surfactants, cationic surfactants, nonionic surfactants, amphoteric surfactants, and combinations thereof, and
(iii) the remainder of the composition comprising water.

A further aspect of the present disclosure relates to an advantageous method of making an aqueous based copolymer emulsion composition comprising the steps of:
i) providing one or more copolymers comprising:
   (a) one or more amine-derivatized alpha-methyl styrene (ADAMS) repeat units according to structure (I):

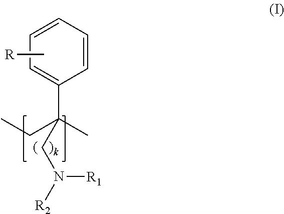

wherein:
   k is an integer from 1 to 3;
   R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof;
   R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof, and
   (b) one or more repeat units according to structures (II), (IIIₐ), (III_{b}), or combinations thereof

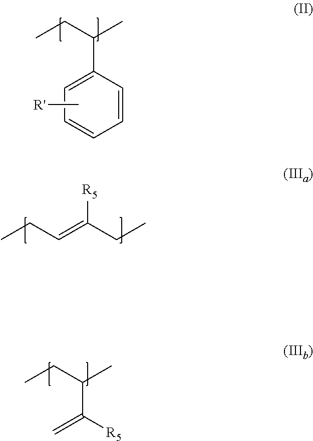

wherein:
   R₅ is a hydrogen or methyl group;
   R′ is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, and/or combinations thereof;
ii) dissolving the one or more copolymers into one or more organic solvents to form one or more dissolved copolymers;
iii) providing an aqueous surfactant solution including one or more surfactants selected from the group consisting of anionic surfactants, cationic surfactants, nonionic surfactants, amphoteric surfactants, and combinations thereof;
iv) combining and mixing the one or more dissolved copolymers and the aqueous surfactant solution;
v) further mixing the combined one or more dissolved copolymers and aqueous surfactant solution to form an emulsified mixture; and
vi) removing the one or more organic solvents from the emulsified mixture to form the aqueous based copolymer emulsion composition.

A still further aspect of the present disclosure relates to an advantageous method of making an aqueous based copolymer emulsion composition comprising the steps of:
i) providing one or more copolymers comprising:
   (a) the reaction product of one or more monomers according to structure (VI)

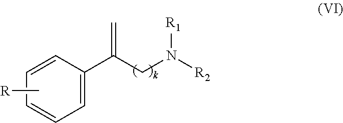

wherein:
   k is an integer from 1 to 3;
   R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof;
   R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof, and
   (b) the reaction product of one or more monomers according to structures (VII), (VIII), or combinations thereof

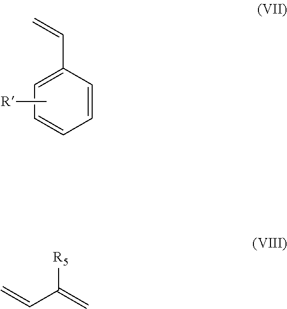

wherein:
   R₅ is a hydrogen or methyl group;
   R′ is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, and/or combinations thereof;
ii) dissolving the one or more copolymers into one or more organic solvents to form one or more dissolved copolymers;
iii) providing an aqueous surfactant solution including one or more surfactants selected from the group consisting of anionic surfactants, cationic surfactants, nonionic surfactants, amphoteric surfactants, and combinations thereof;
iv) combining and mixing the one or more dissolved copolymers and the aqueous surfactant solution;
v) further mixing the combined one or more dissolved copolymers and aqueous surfactant solution to form an emulsified mixture; and
vi) removing the one or more organic solvents from the emulsified mixture to form the aqueous based copolymer emulsion composition.

Other aspects of the present disclosure may become apparent from the Detailed Description and Examples sections hereinbelow.

### DETAILED DESCRIPTION

All numerical values within the detailed description and the claims herein are modified by “about” or “approximately” the indicated value, and take into account experimental error and variations that would be expected by a person having ordinary skill in the art.

### Overview

The present disclosure provides novel aqueous based amine containing copolymer emulsion compositions derived from monomer compositions containing aromatic structures each containing at least one aminic nitrogen. The amine containing copolymer emulsion compositions disclosed herein include surfactant and water, and find particular application as a binder or co-binder for secondary metal ion battery electrodes. Other uses include, but are not limited to, use as a plastic additive, a drag reducing agent, a magneto-rheological fluid, an electro-chlorination additive, an industrial coating additive, an adhesive additive, an asphaltene and wax inhibitor, a refinery anti-foulant, an industrial or household surfactant, an agrochemical additive, a ceramic capacitor or indictor additive, an emulsion explosive additive, an anti-microbial coating, a crude transportation and refining additive, and a carbon-capture additive.

In such application as a binder or co-binder for secondary metal ion battery electrodes, the aqueous based amine containing copolymer emulsion compositions provided herein, provide the following advantages including, but not limited to: improved battery life, improved structural/mechanical integrity of the anode, enhanced charging rate capability and capacity retention, and enhanced processability. The aqueous based amine containing copolymer emulsion compositions disclosed herein may be blended with other components, including, but not limited to, one or more co-binders, one or more conductive carbon-based particles, and one or more of silicon-based particles to form an electrode slurry composition. Also provided herein are methods of improving the life of a secondary metal ion battery by using the electrode slurry composition disclosed herein as a binder for a coating of an anode of the secondary metal ion battery.

The present disclosure also provides methods of making an aqueous based amine containing copolymer emulsion and methods of making an electrode slurry composition for a secondary metal ion battery. The present disclosure also provides methods of using an aqueous based amine containing copolymer emulsion composition and methods of using an electrode slurry composition including the aqueous based amine containing copolymer emulsion as binder or a co-binder for an electrode of a secondary metal ion battery. The present disclosure also provides for a secondary metal ion battery anode that includes one or more copolymer binders or co-binders comprising the one or more amine containing copolymers disclosed herein.

The compositions and methods provided herein are distinguishable over the prior art by including novel aqueous based amine containing copolymer emulsion compositions, which offer significant advantages relative to prior art polymer emulsion compositions including styrene-butadiene rubber and carboxymethyl cellulose.

The advantageous properties and/or characteristics of the disclosed novel aqueous based amine containing copolymer emulsion compositions as binders or co-binders in secondary metal ion battery electrode application include, inter alia, improved battery life, improved structural/mechanical integrity of the anode, enhanced charging rate capability and capacity retention, and enhanced processability.

### Amine Containing Copolymer Emulsion Compositions

i. ADAMS Copolymer Embodiment

In one embodiment, disclosed herein are aqueous based amine containing copolymer emulsion compositions comprising: i) from 1 to 60 wt. %, or 2 to 50 wt. %, or 4 to 40 wt. %, or 6 to 30 wt. %, or 8 to 25 wt. %, or 10 to 20 wt. %, or 13 to 17 wt. % of one or more copolymers comprising: (a) one or more amine-derivatized alpha-methyl styrene (ADAMS) repeat units according to structure (I):

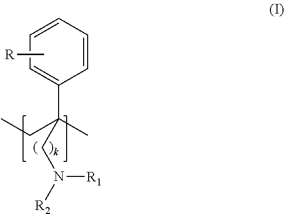

wherein:
   k is an integer from 1 to 3;
   R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof;
   R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof, and
   (b) one or more repeat units according to structures (II), (IIIₐ), (III_{b}), or combinations thereof

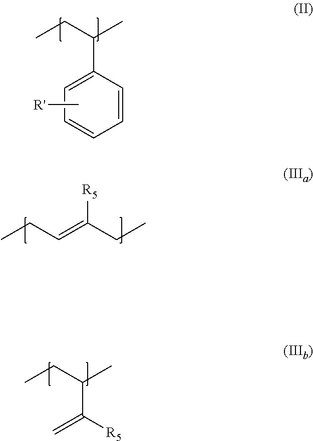

wherein:
   R₅ is a hydrogen or methyl group;
   R′ is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, and/or combinations thereof;
   ii) from 0.05 to 5.0 wt. %, or 0.1 to 4.5 wt. %, or 0.5 to 4.0 wt. %, or 1.0 to 3.5 wt. %, or 1.5 to 3.0 wt. %, or 2.0 to 2.5 wt. % of one or more one or more surfactants selected from the group consisting of anionic surfactants, cationic surfactants, nonionic surfactants, amphoteric surfactants, and combinations thereof; and
   iii) the remainder of the composition comprising water.

In this embodiment, when k=2, the one or more ADAMS repeat units according to structure (I) above may comprise the reacted form of 1-dimethylamino-3-phenylbut-3-ene, 1-diethylamino-3-phenylbut-3-ene, 1-di-n-propylamino-3-phenylbut-3-ene, 1-diisopropylamino-3-phenylbut-3-ene, 1-di-2-propenylamino-3-phenylbut-3-ene, 1-di-n-butylamino-3-phenylbut-3-ene, 1-di-sec-butylamino-3-phenylbut-3-ene, 1-diisobutylamino-3-phenylbut-3-ene, 1-di-tert-butylamino-3-phenylbut-3-ene, 1-cyclohexylmethylamino-3-phenylbut-3-ene, 1-dicyclohexylamino-3-phenylbut-3-ene, 1-di-(2-ethylhexyl)amino-3-phenylbut-3-ene, 1-di-(methoxyethyl)amino-3-phenylbut-3-ene, 1-di-(ethoxyethyl)amino-3-phenylbut-3-ene, 1-di-(phenoxyethyl)amino-3-phenylbut-3-ene, 1-di-(methylthioethyl)amino-3-phenylbut-3-ene, 1-di-(ethylthioethyl)amino-3-phenylbut-3-ene, 1-benzylmethylamino-3-phenylbut-3-ene, 1-dibenzylamino-3-phenylbut-3-ene, 1-benzylphenylamino-3-phenylbut-3-ene, 1-diphenylamino-3-phenylbut-3-ene, 1-dipyridylamino-3-phenylbut-3-ene, 1-phenylmethylamino-3-phenylbut-3-ene, 1-phenylmethoxyethylamino-3-phenylbut-3-ene, 1-benzylmethoxyethylamino-3-phenylbut-3-ene, 1-(N-morpholinyl)-3-phenylbut-3-ene, 1-(N-thiomorpholinyl)-3-phenylbut-3-ene, 1-(N-piperidinyl)-3-phenylbut-3-ene, 1-(N-piperazinyl)-3-phenylbut-3-ene, 1-(N-diazepanyl)-3-phenylbut-3-ene, 1-(N-pyrrolidinyl)-3-phenylbut-3-ene, 1-(N-pyrrolyl)-3-phenylbut-3-ene, 1-(1,2,3,4-tetrahydro-1-quinolinyl)-3-phenylbut-3-ene, 1-(1,2,3,4-tetrahydro-2-isoquinolinyl)-3-phenylbut-3-ene, 1-(N-indolinyl)-3-phenylbut-3-ene, 1-(N-indolyl)-3-phenylbut-3-ene, 1-(N-carbazolyl)-3-phenylbut-3-ene, 1-(N-phenothiazinyl)-3-phenylbut-3-ene, 1-(N-phenothiazinyl-S-oxide)-3-phenylbut-3-ene, 1-(N-phenothiazinyl-S,S-dioxide)-3-phenylbut-3-ene, 1-(N-phenoxazinyl)-3-phenylbut-3-ene, 1-(4-methyl-1-piperazinyl)-3-phenylbut-3-ene, 1-(5-methyl-2,5-diazabicyclo[2.2.1]heptan-2-yl)-3-phenylbut-3-ene, 1-(5-methyl-2,5-diazabicyclo[2.2.2]octan-2-yl)-3-phenylbut-3-ene, 1-(4-cyclopentyl-1-piperazinyl)-3-phenylbut-3-ene, 1-(4-cyclopentadienyl-1-piperazinyl)-3-phenylbut-3-ene, 1-(4-phenyl-1-piperazinyl)-3-phenylbut-3-ene, 1-(4-(thiazolyl)-1-piperazinyl)-3-phenylbut-3-ene, 1-(4-(thiadiazolyl)-1-piperazinyl)-3-phenylbut-3-ene, 1-(4-(triazolyl)-1-piperazinyl)-3-phenylbut-3-ene, 1-(4-(1,2,3-benzotriazolyl)-1-piperazinyl)-3-phenylbut-3-ene, 1-(N′-methyl-N-diazepanyl)-3-phenylbut-3-ene, or a combination thereof.

In this embodiment, the one or more repeat units according to structure (II) above may comprise the reacted form of styrene, and the one or more repeat units according to structures (IIIa) and (IIIb) comprise reacted forms of isoprene, 1,3-butadiene, or a combination thereof.

In this embodiment, the amine containing copolymer may further comprise an alkyl residue from a monofunctional alkyl lithium, alkyl sodium, and/or alkyl potassium initiator present at one or more termini of the polymer backbone; or an alkyl residue from a difunctional alkyl lithium, alkyl sodium, and/or alkyl potassium initiator at about a center of the polymer backbone. The alkyl residues from the monofunctional initiators may include methyl, ethyl, n-propyl, isopropyl, n-butyl, iso-butyl, sec-butyl, tert-butyl, n-amyl, iso-amyl, sec-amyl, tert-amyl, hexyl groups, or combinations thereof, or alternatively, the alkyl residues from difunctional initiators may include propyl, butyl, pentyl, hexyl, 1,4-diphenylbutyl groups, or combinations thereof.

In this embodiment, the amine containing copolymer may be partially or substantially hydrogenated prior to being emulsified. In the context of the present disclosure, partially hydrogenated means that from 10% to 90%, or 20% to 80%, or 30% to 70%, or 40% to 60% of the non-aromatic double bonds have been saturated. Substantially hydrogenated means that greater than 90%, or greater than 92%, or greater than 94%, or greater than 96%, or greater than 98%, or greater than 99%, or greater than 99.5%, or greater than 99.9% of the non-aromatic bonds have been saturated.

In this embodiment, the amine containing copolymer above may have the one or more repeat units of structure (I) interspersed within at least one polymer block comprising the one or more repeat units of structures (II), (IIIa), (IIIb), or combinations thereof.

In this embodiment, the amine containing copolymer above may have the one or more repeat units of structure (I) partially or substantially alternate with the one or more repeat units of structures (II), (III), (IIIb), or combinations thereof, thereby forming one or more repeat units corresponding to structures (IV), (Vₐ), (V_{b}), or combinations thereof:

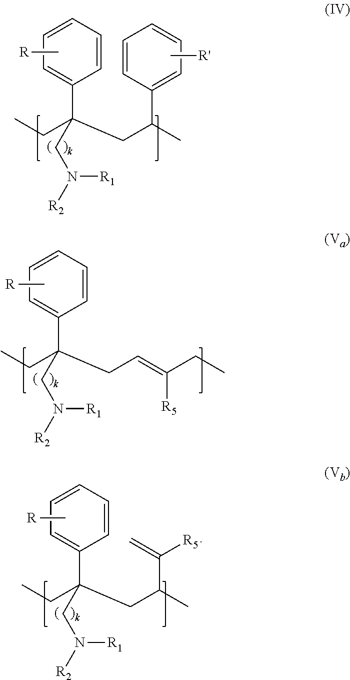

Alternatively, in this embodiment, the amine containing copolymer above may be such that the copolymer comprises one or more additional polymer blocks comprising one or more repeat units of structures (II), (IIIₐ), (III_{b}), or combinations thereof, and not including one or more repeat units according to structure (I). The one or more polymer blocks of the copolymer may form a distributed polymer architecture, a diblock, a triblock, a tetrablock, a pentablock, a hexablock, a star polymer architecture, or combinations thereof.

Alternatively, in this embodiment, the amine containing copolymer mat have an amino group in one or more repeat units of structure (I) which are protonated or alkylated to their corresponding ammonium salt. In this form, the protonated or alkylated ammonium salt may comprise a chloride, bromide, iodide, alkyl or aryl sulfonate, sulfate, phosphate, formate, acetate, propionate, butyrate, benzoate, triflate, nitrate counterion, or a combination thereof.

ii. ADAMS Reaction Product Embodiment

In another embodiment, disclosed herein are aqueous based amine containing copolymer emulsion compositions comprising: i) from 1 to 60 wt. %, or 2 to 50 wt. %, or 4 to 40 wt. %, or 6 to 30 wt. %, or 8 to 25 wt. %, or 10 to 20 wt. %, or 13 to 17 wt. % of one or more copolymers comprising: (a) the reaction product of one or more monomers according to structure (VI)

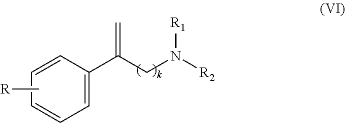

wherein:
   k is an integer from 1 to 3;
   R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof,
   R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof, and
(b) the reaction product of one or more monomers according to structures (VII), (VIII), or combinations thereof

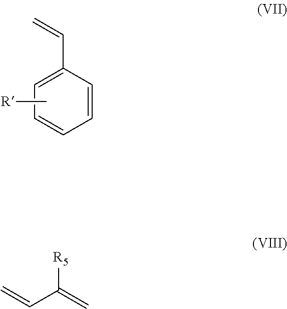

wherein:
   R₅ is a hydrogen or methyl group;
   R′ is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, and/or combinations thereof;
(ii) 0.05 to 5.0 wt. %, or 0.1 to 4.5 wt. %, or 0.5 to 4.0 wt. %, or 1.0 to 3.5 wt. %, or 1.5 to 3.0 wt. %, or 2.0 to 2.5 wt. % of one or more one or more surfactants selected from the group consisting of anionic surfactants, cationic surfactants, nonionic surfactants, amphoteric surfactants, and combinations thereof; and
(iii) the remainder of the composition comprising water.

The aqueous based amine containing copolymer emulsion compositions disclosed herein include the emulsified amine containing copolymer having a particle size ranging from 50 to 1000 nm, or 75 to 950 nm, or 100 to 900 nm, or 125 to 850 nm, or 150 to 800 nm, or 175 to 750 nm, or 200 to 700 nm, or 225 to 650 nm, or 250 to 600 nm, or 275 to 550 nm, or 300 to 500 nm, or 325 to 475 nm, or 350 to 450 nm, or 375 to 425 nm.

The aqueous based amine containing copolymer emulsion compositions disclosed herein may have a pH ranging from 2.0 to 12.0, or 4.0 to 10.0, or 4.5 to 9.5, or 5.0 to 9.0, or 5.5 to 8.5, or 6.0 to 8.0, or 6.5 to 7.5. The aqueous based amine containing copolymer emulsion compositions disclosed herein may have a viscosity at 25 deg. C as measured by ASTM D5133 of from 2 to 1000 cP, or 5 to 950 cP, or 10 to 900 cP, or 20 to 850 cP, or 40 to 800 cP, or 60 to 750 cP, or 80 to 700 cP, or 90 to 650 cP, or 100 to 600 cP, or 150 to 550 cP, or 200 to 500 cP, or 250 to 450 cP, or 300 to 400 cP.

The aqueous based amine containing copolymer emulsion compositions disclosed herein may include one or more surfactants, and more particularly, one or more anionic surfactants, cationic surfactants, nonionic surfactants, amphoteric surfactants, and combinations thereof. The aqueous based amine containing copolymer emulsion compositions disclosed herein may include one or more ionic surfactants that are selected from the group consisting of sodium dodecyl sulfonate, alkyl surfactants, silicone surfactants, fluorine surfactants, metal surfactants, other ionic surfactants described below, and combinations thereof. The aqueous based amine containing copolymer compositions disclosed herein may also include one or more non-ionic surfactants that are selected from the group consisting of silicone surfactants, fluorine surfactants, alkyl surfactants, polyether-based surfactants, other non-ionic surfactants described below, and combinations thereof.

### Amine Containing Copolymers for Use in Emulsion Compositions

The aqueous based copolymer emulsion compositions disclosed herein utilize novel polymers based on anionic polymerization of functionalized styrenic monomers including a nitrogen-containing moiety, other than as pendant to the phenyl ring or. Thus, the monomers of structure (VI) were developed to achieve nitrogen-containing functionality on an alpha-substituted styrenic monomer other than as pendant to the phenyl ring on the styrene unit.

It should be noted that prior art references often describe functionalized styrenic monomer with nitrogen containing groups pendant to the phenyl ring in general terms (e.g. “dimethylaminoethyl styrene”), which can be similar to the k=2 monomer structure provided below, however, the prior art does not teach or suggest the alpha-substituted functional monomers specifically disclosed herein.

The inventive aqueous based copolymer emulsion compositions disclosed herein utilizing functional polymers based on functionalized styrenic monomers including a nitrogen-containing moiety, other than as pendant to the phenyl ring, may be polymerized from addition-polymerizable monomer compositions including one or more amine-derivatized alpha-methyl styrene (ADAMS) monomers according to structure (VI)

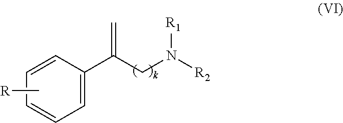

wherein:
   k is an integer from 1 to 3;
   R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof;
   R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof, and

The inventive aqueous based copolymer emulsion compositions disclosed herein utilizing functional polymers based on functionalized styrenic monomers including a nitrogen-containing moiety, other than as pendant to the phenyl ring may be polymerized from the exemplary ADAMS monomers according to structure (VI), which include, but are not limited to, 1-dimethylamino-3-phenylbut-3-ene, 1-diethylamino-3-phenylbut-3-ene, 1-di-n-propylamino-3-phenylbut-3-ene, 1-diisopropylamino-3-phenylbut-3-ene, 1-di-2-propenylamino-3-phenylbut-3-ene, 1-di-n-butylamino-3-phenylbut-3-ene, 1-di-sec-butylamino-3-phenylbut-3-ene, 1-diisobutylamino-3-phenylbut-3-ene, 1-di-tert-butylamino-3-phenylbut-3-ene, 1-cyclohexylmethylamino-3-phenylbut-3-ene, 1-dicyclohexylamino-3-phenylbut-3-ene, 1-di-(2-ethylhexyl)amino-3-phenylbut-3-ene, 1-di-(methoxyethyl)amino-3-phenylbut-3-ene, 1-di-(ethoxyethyl)amino-3-phenylbut-3-ene, 1-di-(phenoxyethyl)amino-3-phenylbut-3-ene, 1-di-(methylthioethyl)amino-3-phenylbut-3-ene, 1-di-(ethylthioethyl)amino-3-phenylbut-3-ene, 1-benzylmethylamino-3-phenylbut-3-ene, 1-dibenzylamino-3-phenylbut-3-ene, 1-benzylphenylamino-3-phenylbut-3-ene, 1-diphenylamino-3-phenylbut-3-ene, 1-dipyridylamino-3-phenylbut-3-ene, 1-phenylmethylamino-3-phenylbut-3-ene, 1-phenylmethoxyethylamino-3-phenylbut-3-ene, 1-benzylmethoxyethylamino-3-phenylbut-3-ene, 1-(N-morpholinyl)-3-phenylbut-3-ene, 1-(N-thiomorpholinyl)-3-phenylbut-3-ene, 1-(N-piperidinyl)-3-phenylbut-3-ene, 1-(N-piperazinyl)-3-phenylbut-3-ene, 1-(N-diazepanyl)-3-phenylbut-3-ene, 1-(N-pyrrolidinyl)-3-phenylbut-3-ene, 1-(N-pyrrolyl)-3-phenylbut-3-ene, 1-(1,2,3,4-tetrahydro-1-quinolinyl)-3-phenylbut-3-ene, 1-(1,2,3,4-tetrahydro-2-isoquinolinyl)-3-phenylbut-3-ene, 1-(N-indolinyl)-3-phenylbut-3-ene, 1-(N-indolyl)-3-phenylbut-3-ene, 1-(N-carbazolyl)-3-phenylbut-3-ene, 1-(N-phenothiazinyl)-3-phenylbut-3-ene, 1-(N-phenothiazinyl-S-oxide)-3-phenylbut-3-ene, 1-(N-phenothiazinyl-S,S-dioxide)-3-phenylbut-3-ene, 1-(N-phenoxazinyl)-3-phenylbut-3-ene, 1-(4-methyl-1-piperazinyl)-3-phenylbut-3-ene, 1-(5-methyl-2,5-diazabicyclo[2.2.1]heptan-2-yl)-3-phenylbut-3-ene, 1-(5-methyl-2,5-diazabicyclo[2.2.2]octan-2-yl)-3-phenylbut-3-ene, 1-(4-cyclopentyl-1-piperazinyl)-3-phenylbut-3-ene, 1-(4-cyclopentadienyl-1-piperazinyl)-3-phenylbut-3-ene, 1-(4-phenyl-1-piperazinyl)-3-phenylbut-3-ene, 1-(4-(thiazolyl)-1-piperazinyl)-3-phenylbut-3-ene, 1-(4-(thiadiazolyl)-1-piperazinyl)-3-phenylbut-3-ene, 1-(4-(triazolyl)-1-piperazinyl)-3-phenylbut-3-ene, 1-(4-(1,2,3-benzotriazolyl)-1-piperazinyl)-3-phenylbut-3-ene, 1-(N′-methyl-N-diazepanyl)-3-phenylbut-3-ene, and combinations thereof.

In some embodiments, the inventive aqueous based copolymer emulsion compositions disclosed herein utilizing functional polymers based on the functionalized styrenic monomers including a nitrogen-containing moiety, other than as pendant to the phenyl ring may be polymerized from the exemplary ADAMS monomers according to structure (VI), may exhibit a k value of exactly 2.

For clarity, and as used herein, the inventive aqueous based copolymer emulsion compositions disclosed herein utilizing functional polymers based on the functionalized styrenic monomers including a nitrogen-containing moiety, other than as pendant to the phenyl ring may be polymerized from the exemplary ADAMS monomers of structure (VI) having a vinylidene bond, such as originating from the olefinic double-bond in alpha-methylstyrene, which can be reflected in -3-ene/-3-enyl language of the IUPAC nomenclature, for example.

The inventive aqueous based copolymer emulsion compositions disclosed herein utilizing polymer compositions disclosed herein may optionally contain residues of initiators and/or co-initiators that are, or may be, used in living or pseudo-living anionic polymerization reactions. Non-limiting examples may include alkyl residues from sec-butyllithium, n-butyllithium, tert-butyllithium, and the like, and combinations, reaction products, and/or degradation products thereof.

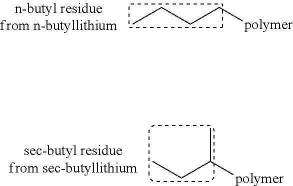

The alkyl residues from monofunctional initiators may optionally be present at one or more termini of the polymer backbone, while alkyl residues of difunctional initiators may optionally be present at about the center of the polymer backbone.

The monofunctional initiator which may be used may be an alkyl lithium, alkyl sodium, or alkyl potassium compound, generally in the C2 to C12 range. Alkyl lithium compounds such as methyllithium, ethyllithium, n-propyllithium, isopropylithium, n-butyllithium, iso-butyllithium, sec-butyllithium, tert-butyllithium, n-amyllithium, iso-amyllithium, sec-amyllithium, tert-amyllithium, hexyllithium, or a combination thereof, are preferred. Secondary alkyl lithium compounds, such as sec-butyllithium, sec-amyllithium, or a combination thereof, are more preferred. Most preferred is sec-butyllithium. Substituted alkyllithiums may also be used, such as aralkyllithium compounds, for example, benzyllithium, 1-lithioethylbenzene, and 1-lithio-3-methylpentylbenzene.

The difunctional initiator which may be used may be an alkyl dilithium, alkyl disodium, or alkyl dipotassium compound, generally in the C2 to C12 range, such as 1,3-propanediyldilithium, 1,4-butanediyldilithium, 1,5-pentanediyldilithium, 1,6-hexanedilyllithium, or a combination thereof. Additional difunctional initiators are disclosed in U.S. Pat. No. 6,492,469, which is herein incorporated by reference in its entirety.

The inventive aqueous based copolymer emulsion compositions disclosed herein utilizing functional polymers based on functionalized styrenic monomers including a nitrogen-containing moiety, other than as pendant to the phenyl ring, may be preferentially polymerized via anionic polymerization processes. However, additionally or alternatively, the functional polymers disclosed herein based on functionalized styrenic monomers including a nitrogen-containing moiety, other than as pendant to the phenyl ring, may optionally utilize initiators and/or co-initiators that are, or may be, used in (free) radical polymerization reactions. Non-limiting examples may include, but are not necessarily limited to, azibisisobutyronitrile (AIBN), di-tert-butyl peroxide, and the like, and combinations, reaction products, and/or degradation products thereof.

Provided herein are inventive aqueous based copolymer emulsion compositions utilizing anionically polymerized polymers derived from functionalized styrenic monomers including a nitrogen-containing moiety, other than as pendant to the phenyl ring. More particularly, the functionalized styrenic monomers including a nitrogen-containing moiety, other than as pendant to the phenyl ring have the general structure:

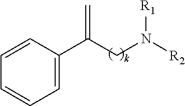

wherein R₁ and R₂ are each independently a hydrocarbyl group or a hydrocarbonaceous group having 1 to 4 additional heteroatoms, such as O, N, S, P, Se, and combinations thereof, or wherein R₁ and R₂ are connected to form a moiety containing at least one 5-to 12-membered ring, from 3 to 24 carbons, and optionally 1 to 6 additional heteroatoms (such as O, N, S, P, Se, and combinations thereof). Monomers with k=2 are preferable due to ease of monomer synthesis and favorable reactivity in the polymerization. Alternatively, monomers with k≥3 may be used, but are more complex to prepare and are less commercially feasible. Alternatively, monomers with k=1 may be used, but are difficult to polymerize via anionic polymerization.

The functionalized styrenic monomers including a nitrogen-containing moiety, other than as pendant to the phenyl ring, may be alternatively co-polymerized with isoprene, butadiene, styrene, and combinations thereof. Other non-limiting exemplary co-monomers that may be co-polymerized with the functionalized styrenic monomers including a nitrogen-containing moiety, other than as pendant to the phenyl ring, include, various alkyl-substituted styrenes (i.e. 2-methylstyrene, 3-methylstyrene, 4-methylstyrene, 4-ethylstyrene, 4-n-butylstyrene, 4-tert-butylstyrene, 2,4-dimethylstyrene, 3,5-dimethylstyrene, 2,4,6-trimethylstyrene, 2,4-diethylstyrene, 3,5-diethylstyrene, 2,4-dipropylstyrene, 2-methyl-4-ethylstyrene, 2-methyl-4-propylstyrene, and the like), vinylnaphthalene, vinylpyridine, piperylene, methylpentyldiene, or a combination thereof. In another form, the functionalized styrenic monomers including a nitrogen-containing moiety, other than as pendant to the phenyl ring, may be homopolymerized, either as an isolable homopolymer or a homopolymer block in a copolymer.

Depending on the reactivity ratios of the styrenic monomers including a nitrogen-containing moiety, other than as pendant to the phenyl ring, and the other co-monomers present in the polymerization reaction, the repeat units of structure (I) may, in some cases, form alternating structures with the repeat units of structures (II), (IIIₐ), (III_{b}), or a combination thereof. For example, the reaction below, wherein R₁, R₂, and R₅, have the same meanings as indicated above.

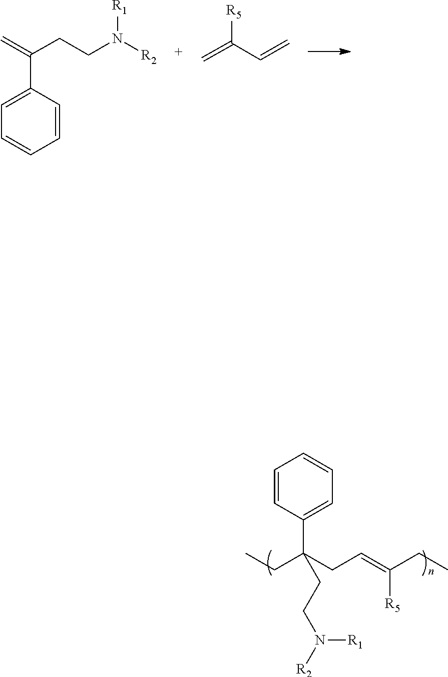

The alternating structures formed as a combination of repeat units of structure (I) with structures (II), (IIIₐ), (III_{b}), or a combination thereof, would thereby form larger repeat units of structures (IV), (Vₐ), (V_{b}), or a combination thereof.

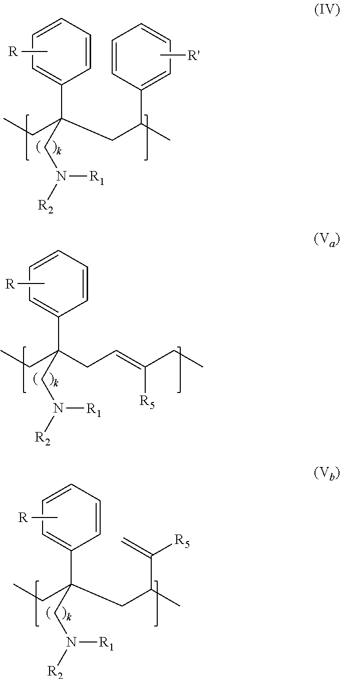

Wherein, k is an integer from 1 to 3; R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof; R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof, R₅ is a hydrogen or methyl group.

Additionally, depending on the reactivity ratios of the styrenic monomers including a nitrogen-containing moiety, other than as pendant to the phenyl ring and the other co-monomers present in the polymerization reaction, and where a molar excess of one or more other co-monomers is present in the polymerization reaction, the polymer may in some cases form a block of repeat units of structures (IV), (Vₐ), (V_{b}), or a combination thereof, followed by a block of repeat units of structures (II), (IIIₐ), (III_{b}) or a combination thereof, absent of repeat units of structures (IV), (Vₐ), (V_{b}). For example, the reaction below, wherein R₁, R₂, and R₅ have the same meanings as indicated above.

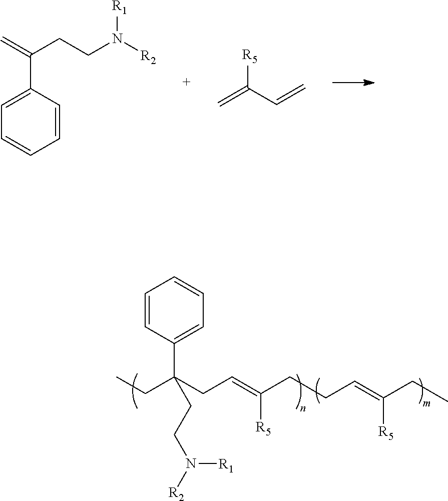

In some embodiments, different monomers, or combinations thereof, may optionally be added to the polymerization reaction sequentially. In such cases, those monomers added later in the reaction may form a block of repeat units within the polymer with a different composition to those repeat units from monomers earlier in the polymerization.

In cases where the polymer contains two blocks of repeat units with different composition, either as a result of differences in the monomer reactivity ratios or from sequential addition of monomers to the polymerization reaction, the polymer is described as a ‘diblock’. Similarly, when the polymer contains three, four, five, or six blocks of repeat units of different composition, either as a result of differences in the monomer reactivity ratios or from sequential addition of monomers to the polymerization reaction, the polymers are described as ‘triblock’, ‘tetrablock’, ‘pentablock’, or ‘hexablock’, respectively.

In some embodiments, the polymer may be coupled using a polyfunctional coupling agent to form a polymer with a star architecture. Many suitable types of these polyfunctional compounds have been described in U.S. Pat. Nos. 3,595,941; 3,468,972, 3,135,716; 3,078,254, and 3,594,452, the disclosures of which are herein incorporated by reference in their entirety. The polyfunctional coupling agent may optionally be a halogen-substituted or alkoxy-substitued silane, including, tetrachlorosilane, tetramethoxysilane, tetraethoxysilane, bis-trimethoxy-silylethane, bis-triethoxy-silylethane, hexachlorodisiloxane, bis-trichlorosilylethane, 1,6-bis(trichlorosilyl)-hexane, or a combination thereof.

A preferred coupling agent is a polyalkenyl aromatic coupling agent. The most preferred coupling agent is divinyl benzene. Polyalkenyl aromatic coupling agents capable of forming star shaped polymers are known in the art. See generally, Canadian patent number 716,645 and U.S. Pat. Nos. 4,010,226 and 3,985,830 which are herein incorporated by reference in their entirety. A detailed description of a variety of such coupling agents is found in U.S. Pat. No. 4,391,949 which is herein incorporated by reference in its entirety. Examples of suitable polyvinyl aromatic compounds are 1,2-divinyl benzene, 1,3-divinylbenzene, 1,4-divinylbenzene, 1,2,4-trivinylbenzene, 1,3-divinylnaphthalene, 1,8-divinylnaphthalene, 1,3,5trivinylnaphthalene, 2,4-divinylbiphenyl, 3,5,4′-trivinylbiphenyl, 1,2-divinyl-3, 4-dimethylbenzene, 1,5,6-trivinyl-3,7-diethylnaphthalene, 1,3-divinyl-4, 5,6-tributyl naphthalene, 2,2′-divinyl-4-ethyl-4′-propylbiphenyl and the like, or a combination thereof.

In cases where a polyfunctional coupling agent is used to couple a polymer to form a polymer star architecture, the coupling ratio (CR) is used to refer to the amount of the polymer that has been crosslinked into a star architecture, meaning the percentage by weight of the polymer in a star architecture relative to the total weight of polymer in the sample. In some embodiments, the inventive functional polymers disclosed herein based on functionalized styrenic monomers including a nitrogen-containing moiety including a star polymer architecture may have a CR greater than 20%, or greater than 30%, or greater than 40%, or greater than 50%, or greater 60%, or greater than 70%, or greater than 80%, or greater than 90%, or greater than 95%.

In some embodiments, the inventive aqueous based copolymer emulsion compositions disclosed herein utilizing functional polymers based on functionalized styrenic monomers including a nitrogen-containing moiety, other than as pendant to the phenyl ring, may have a number average molecular weight, Mn, of greater than 500 Da, or greater than 1000 Da, or greater than 2000 Da, or greater than 5000 Da, or greater than 10,000 Da. Additionally or alternatively, the inventive aqueous based copolymer emulsion compositions disclosed herein utilizing functional polymers based on functionalized styrenic monomers including a nitrogen-containing moiety, other than as pendant to the phenyl ring, may have a number average molecular weight, Mn, of less than 5,000,000 Da, or less than 3,000,000 Da, or less than 1,000,000 Da, or less than 500,000 Da, or less than 200,000 Da.

In some embodiments, the inventive aqueous based copolymer emulsion compositions disclosed herein utilizing functional polymers based on functionalized styrenic monomers including a nitrogen-containing moiety, other than as pendant to the phenyl ring, may contain greater than 0.01 wt %, or greater than 0.05 wt %, or greater than 0.1 wt %, or greater than 0.5 wt %, or greater than 1.0 wt %, or greater than 5.0 wt %, or greater than 10 wt %, of repeat units according to structure (I).

In some embodiments, the inventive aqueous based copolymer emulsion compositions disclosed herein utilizing functional polymers based on functionalized styrenic monomers including a nitrogen-containing moiety, other than as pendant to the phenyl ring, may contain greater than 0.01 wt %, or greater than 0.05 wt %, or greater than 0.1 wt %, or greater than 0.5 wt %, or greater than 1.0 wt %, or greater than 5.0 wt %, or greater than 10 wt %, of repeat units according to structure (IV), (Vₐ), (V_{b}), or combinations thereof.

In some embodiments, the inventive aqueous based copolymer emulsion compositions disclosed herein utilizing functional polymers based on functionalized styrenic monomers including a nitrogen-containing moiety, other than as pendant to the phenyl ring, may optionally be further subjected to post-polymerization modification in order to modify their structure.

In some embodiments, the post-polymerization modification is hydrogenation. Hydrogenation can be carried out in the process of the present disclosure by known catalysis systems, including heterogeneous systems and soluble systems. Soluble systems are disclosed in U.S. Pat. No. 4,284,835 at column 1, line 65 through column 9, line 16, as well as U.S. Pat. No. 4,980,331 at column 3 line 40 through column 6, line 28, both of which are herein incorporated by reference.

The hydrogenated copolymers described above may be partially or substantially hydrogenated. In the context of the present disclosure, partially hydrogenated means that from 10% to 90%, or 20% to 80%, or 30% to 70%, or 40% to 60% of the non-aromatic double bonds have been saturated. Substantially hydrogenated means that greater than 90%, or greater than 92%, or greater than 94%, or greater than 96%, or greater than 98%, or greater than 99%, or greater than 99.5%, or greater than 99.9% of the non-aromatic bonds have been saturated.

Additional teachings to hydrogenation may be found in Rachapudy et al., Journal of Polymer Science: Polymer Physics Edition, Vol. 17, 1211-1222 (1979), which is incorporated herein by reference in its entirety. Table 1 of the article discloses several systems including palladium on various supports (calcium carbonate, but also barium sulfide). The Rachapudy et al. article discloses preparation of homogeneous catalysts and heterogeneous catalysts.

Additional teachings to hydrogenation processes and catalysts are disclosed in U.S. Pat. Nos. 4,284,835 and 4,980,331, both of which are incorporated herein by reference in their entirety.

In some embodiments, the post-polymerization modification may be a deprotection reaction which removes a cleavable chemical protecting group from the repeat units of structures (I), (IV), (Vₐ), (V_{b}), or a combination thereof. A cleavable chemical protecting group means a chemical group which is inert under the polymerization reaction conditions, but can be removed with post-polymerization chemistry to yield a free —NH— or a free —NH2 functional group on the ADAMS repeat unit. In one such form, a preferred cleavable chemical protecting group is a benzyl group and the deprotection reaction is a hydrogenation reaction.

In some embodiments, the post-polymerization modification is a protonation reaction, wherein one or more amine functional groups within repeat units of structures (I), (IV), (Vₐ), (V_{b}), or a combination thereof, are converted to their corresponding ammonium salts by treatment with a protic acid. The protic acid may be any acid which is sufficiently strong to protonate a basic nitrogen atom in the repeat units of structures (I), (IV), (Vₐ), (V_{b}), or a combination thereof, and thereby form an ammonium salt of the repeat unit with a counterion corresponding to the conjugate base of the protic acid. Non-limiting examples of the protic acid may include hydrochloric acid, hydrobromic acid, hydroiodic acid, various alkyl or aryl sulfonic acids (i.e. methylsulfonic acid, ethylsulfonic acid, propylsulfonic acid, n-butylsulfonic acid, tert-butylsulfonic acid, benzenesulfonic acid, p-toluenesulfonic acid, p-dodecylbenzenesulfonic acid, and the like), sulfuric acid, phosphoric acid, formic acid, acetic acid, butyric acid, benzoic acid, triflic acid, nitric acid, or a combination thereof, which would yield ammonium salts with respectively chloride, bromide, iodide, alkyl or aryl sulfonate, sulfate, phosphate, formate, acetate, propionate, butyrate, benzoate, triflate, nitrate counterion, or a combination thereof, counterions.

In some embodiments, the post-polymerization modification is an alkylation reaction, wherein one or more amine functional groups within repeat units of structures (I), (IV), (Vₐ), (V_{b}), or a combination thereof, are converted to their corresponding ammonium salts by treatment with an alkylating agent. Non-limiting examples of alkylating agents may include various alkyl halides (i.e. bromomethane, iodomethane, bromoethane, iodoethane, bromopropane, iodopropane, benzyl chloride, benzyl bromide, benzyl iodide, and the like), various alkyl sulfonates (i.e. methyl tosylate, ethyl tosylate, propyl tosylate, benzyl tosylate, methyl methanesulfonate, ethyl methanesulfonate, propyl methanesulfonate, benzyl methanesulfonate, and the like), various alkly triflates (i.e. methyl triflate, ethyl triflate, propyl triflate, and the like), or a combination thereof, which would yield ammonium salts with counterions corresponding to the displaced leaving groups of the alkylating agent.

### ADAMS Copolymers for Use in Emulsion Compositions

In one form of the invention disclosed herein, the aqueous based copolymer emulsion compositions utilize copolymer compositions based on amine-derivatized alpha-methyl styrene (ADAMS) monomer (referred to also as ADAMS copolymers) are polymerized via anionic polymerization processing. In particular, in one form the ADAMS copolymers include the following: (a) one or more amine-derivatized alpha-methyl styrene (ADAMS) repeat units according to structure (I):

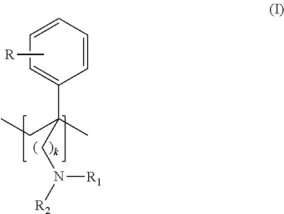

wherein: k is an integer from 1 to 3; R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof; R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof, and (b) one or more repeat units according to structures (II), (IIIₐ), (III_{b}), or combinations thereof

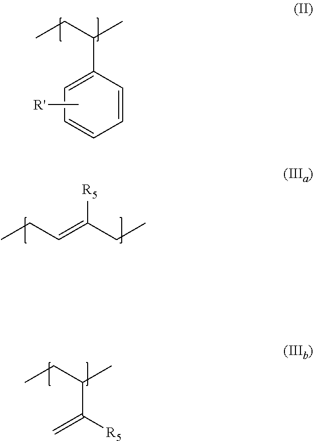

wherein: R₅ is a hydrogen or methyl group; R′ is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, and/or combinations thereof. With regard to the polymeric repeat unit of structure (IIIₐ) above, it may be in the cis-isomer form, the trans-isomer form, or combinations thereof.

In an advantageous form, k=2 for the ADAMS copolymers described above.

The above copolymers may include one or more ADAMS repeat units according to structure (I), which comprise the reacted form of the following: 1-dimethylamino-3-phenylbut-3-ene, 1-diethylamino-3-phenylbut-3-ene, 1-di-n-propylamino-3-phenylbut-3-ene, 1-diisopropylamino-3-phenylbut-3-ene, 1-di-2-propenylamino-3-phenylbut-3-ene, 1-di-n-butylamino-3-phenylbut-3-ene, 1-di-sec-butylamino-3-phenylbut-3-ene, 1-diisobutylamino-3-phenylbut-3-ene, 1-di-tert-butylamino-3-phenylbut-3-ene, 1-cyclohexylmethylamino-3-phenylbut-3-ene, 1-dicyclohexylamino-3-phenylbut-3-ene, 1-di-(2-ethylhexyl)amino-3-phenylbut-3-ene, 1-di-(methoxyethyl)amino-3-phenylbut-3-ene, 1-di-(ethoxyethyl)amino-3-phenylbut-3-ene, 1-di-(phenoxyethyl)amino-3-phenylbut-3-ene, 1-di-(methylthioethyl)amino-3-phenylbut-3-ene, 1-di-(ethylthioethyl)amino-3-phenylbut-3-ene, 1-benzylmethylamino-3-phenylbut-3-ene, 1-dibenzylamino-3-phenylbut-3-ene, 1-benzylphenylamino-3-phenylbut-3-ene, 1-diphenylamino-3-phenylbut-3-ene, 1-dipyridylamino-3-phenylbut-3-ene, 1-phenylmethylamino-3-phenylbut-3-ene, 1-phenylmethoxyethylamino-3-phenylbut-3-ene, 1-benzylmethoxyethylamino-3-phenylbut-3-ene, 1-(N-morpholinyl)-3-phenylbut-3-ene, 1-(N-thiomorpholinyl)-3-phenylbut-3-ene, 1-(N-piperidinyl)-3-phenylbut-3-ene, 1-(N-piperazinyl)-3-phenylbut-3-ene, 1-(N-diazepanyl)-3-phenylbut-3-ene, 1-(N-pyrrolidinyl)-3-phenylbut-3-ene, 1-(N-pyrrolyl)-3-phenylbut-3-ene, 1-(1,2,3,4-tetrahydro-1-quinolinyl)-3-phenylbut-3-ene, 1-(1,2,3,4-tetrahydro-2-isoquinolinyl)-3-phenylbut-3-ene, 1-(N-indolinyl)-3-phenylbut-3-ene, 1-(N-indolyl)-3-phenylbut-3-ene, 1-(N-carbazolyl)-3-phenylbut-3-ene, 1-(N-phenothiazinyl)-3-phenylbut-3-ene, 1-(N-phenothiazinyl-S-oxide)-3-phenylbut-3-ene, 1-(N-phenothiazinyl-S,S-dioxide)-3-phenylbut-3-ene, 1-(N-phenoxazinyl)-3-phenylbut-3-ene, 1-(4-methyl-1-piperazinyl)-3-phenylbut-3-ene, 1-(5-methyl-2,5-diazabicyclo[2.2.1]heptan-2-yl)-3-phenylbut-3-ene, 1-(5-methyl-2,5-diazabicyclo[2.2.2]octan-2-yl)-3-phenylbut-3-ene, 1-(4-cyclopentyl-1-piperazinyl)-3-phenylbut-3-ene, 1-(4-cyclopentadienyl-1-piperazinyl)-3-phenylbut-3-ene, 1-(4-phenyl-1-piperazinyl)-3-phenylbut-3-ene, 1-(4-(thiazolyl)-1-piperazinyl)-3-phenylbut-3-ene, 1-(4-(thiadiazolyl)-1-piperazinyl)-3-phenylbut-3-ene, 1-(4-(triazolyl)-1-piperazinyl)-3-phenylbut-3-ene, 1-(4-(1,2,3-benzotriazolyl)-1-piperazinyl)-3-phenylbut-3-ene, 1-(N′-methyl-N-diazepanyl)-3-phenylbut-3-ene, or a combination thereof.

In another form, the ADAMS copolymers described above may be such that the one or more repeat units according to structure (II) comprise the reacted form of styrene, and the one or more repeat units according to structures (IIIₐ) and (III_{b}) comprise reacted forms of isoprene, 1,3-butadiene, or a combination thereof. With regard to the polymeric repeat unit of structure (IIIₐ), it may be in the cis-isomer form, the trans-isomer form, or combinations thereof.

Alternatively, the ADAMS copolymers may further include an alkyl residue from a monofunctional alkyl lithium, alkyl sodium, and/or alkyl potassium initiator present at one or more termini of the polymer backbone; or an alkyl residue from a difunctional alkyl lithium, alkyl sodium, and/or alkyl potassium initiator at about a center of the polymer backbone. For the alkyl residues from the monofunctional initiators, such alkyl residues may include methyl, ethyl, n-propyl, isopropyl, n-butyl, iso-butyl, sec-butyl, tert-butyl, n-amyl, iso-amyl, sec-amyl, tert-amyl, hexyl groups, or combinations thereof. For the alkyl residues from such difunctional initiators may include propyl, butyl, pentyl, hexyl, 1,4-diphenylbutyl groups, or combinations thereof.

Alternatively, the ADAMS copolymers described above may be partially or substantially hydrogenated. Partially hydrogenated means that from 10% to 90%, or 20% to 80%, or 30% to 70%, or 40% to 60% of the non-aromatic double bonds have been saturated. Substantially hydrogenated means that greater than 90%, or greater than 92%, or greater than 94%, or greater than 96%, or greater than 98%, or greater than 99%, or greater than 99.5%, or greater than 99.9% of the non-aromatic bonds have been saturated.

Alternatively, the ADAMS copolymers described above may be such that the one or more repeat units of structure (I) are interspersed within at least one polymer block comprising the one or more repeat units of structures (II), (IIIₐ), (III_{b}), or combinations thereof. Still alternatively, the ADAMS copolymers described above may be such that the one or more repeat units of structure (IV) may partially or substantially alternate with the one or more repeat units of structures (II), (IIIₐ), (III_{b}), or combinations thereof, thereby forming one or more repeat units corresponding to structures (IV), (Vₐ), (V_{b}), or combinations thereof:

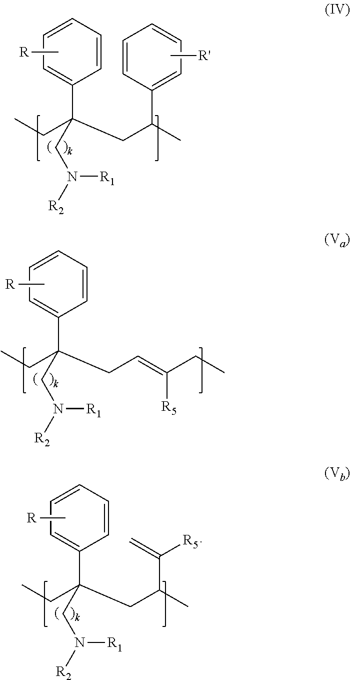

Partially alternate means that from 10% to 90%, or 20% to 80%, or 30% to 70%, or 40% to 60% of the one or more repeat units of structure (I) alternate with the one or more repeat units of structures (II), (IIIₐ), (III_{b}), or combinations thereof. Substantially alternate means that greater than 90%, or greater than 92%, or greater than 94%, or greater than 96%, or greater than 98%, or greater than 99%, or greater than 99.5%, or greater than 99.9% of the one or more repeat units of structure (I) alternate with the one or more repeat units of structures (II), (IIIₐ), (III_{b}), or combinations thereof.

In still another form, the ADAMS copolymers described above may include one or more polymer blocks comprising one or more repeat units of structures (II), (IIIₐ), (III_{b}), or combinations thereof, and not including one or more repeat units according to structure (I). In such a form, the one or more polymer blocks of the copolymer may form a distributed polymer architecture, a diblock, a triblock, a tetrablock, a pentablock, a hexablock, a star polymer architecture, or combinations thereof. A distributed polymer architecture means that repeat units of structure (I) are either randomly or uniformly distributed throughout a larger block of non-ADAMS repeat units, which means that greater than 3, or greater than 5, or greater than 10, or greater 15, or greater than 20 repeat units of the non-ADAMS monomer are joined between ADAMS repeat units.

In still another form, the ADAMS copolymers described above may be such that wherein in structure (I), R₁, R₂, R′₁, R′₂, or a combination thereof, are cleavable chemical protecting groups. A cleavable chemical protecting group means a chemical group which is inert under the polymerization reaction conditions, but can be removed with post-polymerization chemistry to yield a free —NH— or a free —NH2 functional group on the ADAMS repeat unit. In one such a form, the at least one cleavable chemical protecting group is a benzyl group.

In still another form, the ADAMS copolymers described above may further include one or more —OH, —NH—, or —NH₂ functional groups, or a combination thereof, at one or more termini of the copolymer backbone.

In still yet another form, the ADAMS copolymers described above may be such that wherein an amino group in one or more repeat units of structure (I) are protonated or alkylated to their corresponding ammonium salt. In such a form, the protonated or alkylated ammonium salt may include a chloride, bromide, iodide, alkyl or aryl sulfonate, sulfate, phosphate, formate, acetate, propionate, butyrate, benzoate, triflate, nitrate counterion, or a combination thereof.

In particular, in one form the ADAMS copolymers disclosed herein, the ADAMS copolymers include the following: (a) a copolymer comprising the reaction product of: (a) one or more monomers according to structure (VI)

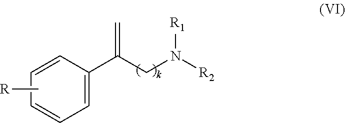

wherein: k is an integer from 1 to 3; R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof; R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof, (b) isoprene, 1,3-butadiene, styrene, or a combination thereof, and (c) an alkyl lithium, alkyl sodium, alkyl potassium initiator, or a combination thereof.

The above copolymers may include one or more monomers comprising 1-dimethylamino-3-phenylbut-3-ene, 1-diethylamino-3-phenylbut-3-ene, 1-di-n-propylamino-3-phenylbut-3-ene, 1-diisopropylamino-3-phenylbut-3-ene, 1-di-2-propenylamino-3-phenylbut-3-ene, 1-di-n-butylamino-3-phenylbut-3-ene, 1-di-sec-butylamino-3-phenylbut-3-ene, 1-diisobutylamino-3-phenylbut-3-ene, 1-di-tert-butylamino-3-phenylbut-3-ene, 1-cyclohexylmethylamino-3-phenylbut-3-ene, 1-dicyclohexylamino-3-phenylbut-3-ene, 1-di-(2-ethylhexyl)amino-3-phenylbut-3-ene, 1-di-(methoxyethyl)amino-3-phenylbut-3-ene, 1-di-(ethoxyethyl)amino-3-phenylbut-3-ene, 1-di-(phenoxyethyl)amino-3-phenylbut-3-ene, 1-di-(methylthioethyl)amino-3-phenylbut-3-ene, 1-di-(ethylthioethyl)amino-3-phenylbut-3-ene, 1-benzylmethylamino-3-phenylbut-3-ene, 1-dibenzylamino-3-phenylbut-3-ene, 1-benzylphenylamino-3-phenylbut-3-ene, 1-diphenylamino-3-phenylbut-3-ene, 1-dipyridylamino-3-phenylbut-3-ene, 1-phenylmethylamino-3-phenylbut-3-ene, 1-phenylmethoxyethylamino-3-phenylbut-3-ene, 1-benzylmethoxyethylamino-3-phenylbut-3-ene, 1-(N-morpholinyl)-3-phenylbut-3-ene, 1-(N-thiomorpholinyl)-3-phenylbut-3-ene, 1-(N-piperidinyl)-3-phenylbut-3-ene, 1-(N-piperazinyl)-3-phenylbut-3-ene, 1-(N-diazepanyl)-3-phenylbut-3-ene, 1-(N-pyrrolidinyl)-3-phenylbut-3-ene, 1-(N-pyrrolyl)-3-phenylbut-3-ene, 1-(1,2,3,4-tetrahydro-1-quinolinyl)-3-phenylbut-3-ene, 1-(1,2,3,4-tetrahydro-2-isoquinolinyl)-3-phenylbut-3-ene, 1-(N-indolinyl)-3-phenylbut-3-ene, 1-(N-indolyl)-3-phenylbut-3-ene, 1-(N-carbazolyl)-3-phenylbut-3-ene, 1-(N-phenothiazinyl)-3-phenylbut-3-ene, 1-(N-phenothiazinyl-S-oxide)-3-phenylbut-3-ene, 1-(N-phenothiazinyl-S,S-dioxide)-3-phenylbut-3-ene, 1-(N-phenoxazinyl)-3-phenylbut-3-ene, 1-(4-methyl-1-piperazinyl)-3-phenylbut-3-ene, 1-(5-methyl-2,5-diazabicyclo[2.2.1]heptan-2-yl)-3-phenylbut-3-ene, 1-(5-methyl-2,5-diazabicyclo[2.2.2]octan-2-yl)-3-phenylbut-3-ene, 1-(4-cyclopentyl-1-piperazinyl)-3-phenylbut-3-ene, 1-(4-cyclopentadienyl-1-piperazinyl)-3-phenylbut-3-ene, 1-(4-phenyl-1-piperazinyl)-3-phenylbut-3-ene, 1-(4-(thiazolyl)-1-piperazinyl)-3-phenylbut-3-ene, 1-(4-(thiadiazolyl)-1-piperazinyl)-3-phenylbut-3-ene, 1-(4-(triazolyl)-1-piperazinyl)-3-phenylbut-3-ene, 1-(4-(1,2,3-benzotriazolyl)-1-piperazinyl)-3-phenylbut-3-ene, 1-(N′-methyl-N-diazepanyl)-3-phenylbut-3-ene, or a combination thereof.

### Methods of Using the Emulsion Composition Based on ADAMS Copolymers

The aqueous based copolymer emulsion compositions disclosed herein utilizing the nitrogen containing copolymers based on anionic polymerization of functionalized styrenic monomers including a nitrogen-containing moiety, other than as pendant to the phenyl ring, may be used for a range of different applications. In particular, the inventive aqueous based copolymer emulsion compositions disclosed herein utilizing functional polymers based on functionalized styrenic monomers including a nitrogen-containing moiety, other than as pendant to the phenyl ring, may be used according to the methods below.

In one embodiment of the method of using the aqueous based copolymer emulsion compositions disclosed herein, the method comprises the steps of: 1) providing a copolymer emulsion composition comprising:
i) from 1 to 60 wt. % of one or more copolymers comprising:
   (a) one or more amine-derivatized alpha-methyl styrene (ADAMS) repeat units according to structure (I):

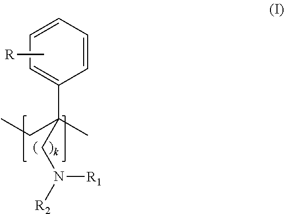

wherein:
   k is an integer from 1 to 3;
   R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof;
   R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof, and
   (b) one or more repeat units according to structures (II), (IIIₐ), (III_{b}), or combinations thereof

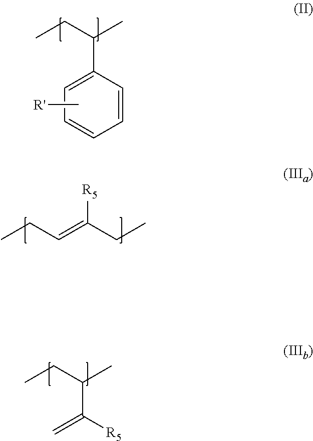

wherein:
   R₅ is a hydrogen or methyl group;
   R′ is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, and/or combinations thereof;
   ii) from 0.05 to 5.0 wt. %, or 0.1 to 4.5 wt. %, or 0.5 to 4.0 wt. %, or 1.0 to 3.5 wt. %, or 1.5 to 3.0 wt. %, or 2.0 to 2.5 wt. % of one or more one or more surfactants selected from the group consisting of anionic surfactants, cationic surfactants, nonionic surfactants, amphoteric surfactants, and combinations thereof; and
   iii) the remainder of the composition comprising water; and 2) using the emulsion composition or an additive mixture including the emulsion composition in an application selected from the group consisting of a secondary metal ion battery additive, a plastic additive, a drag reducing agent, a magneto-rheological fluid, an electro-chlorination additive, an industrial coating additive, an adhesive additive, an asphaltene and wax inhibitor, a refinery anti-foulant, an industrial or household surfactant, an agrochemical additive, a ceramic capacitor or indictor additive, an emulsion explosive additive, an anti-microbial coating, a crude transportation and refining additive, and a carbon-capture additive. One particularly preferred application of the aqueous based copolymer emulsion compositions disclosed herein is as a secondary metal ion battery additive, and more particularly as a secondary metal ion battery slurry composition for coating the battery anode or cathode.

In another embodiment of the method of using the aqueous based copolymer emulsion compositions disclosed herein comprises the steps of: 1) providing a copolymer emulsion composition comprising:
i) from 1 to 60 wt. % of one or more copolymers comprising:
   (a) the reaction product of one or more monomers according to structure (VI)

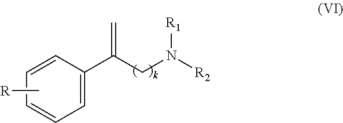

wherein:
   k is an integer from 1 to 3;
   R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof;
   R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof, and
   (b) the reaction product of one or more monomers according to structures (VII), (VIII), or combinations thereof

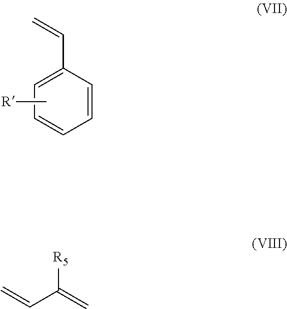

wherein:
   R₅ is a hydrogen or methyl group;
   R′ is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, and/or combinations thereof;
   (ii) from 0.05 to 5.0 wt. % of one or more surfactants selected from the group consisting of anionic surfactants, cationic surfactants, nonionic surfactants, amphoteric surfactants, and combinations thereof; and
   (iii) the remainder of the composition comprising water, and
   2) using the emulsion composition or an additive mixture including the emulsion in an application selected from the group consisting of a secondary metal ion battery additive, a plastic additive, a drag reducing agent, a magneto-rheological fluid, an electro-chlorination additive, an industrial coating additive, an adhesive additive, an asphaltene and wax inhibitor, a refinery anti-foulant, an industrial or household surfactant, an agrochemical additive, a ceramic capacitor or indictor additive, an emulsion explosive additive, an anti-microbial coating, a crude transportation and refining additive, and a carbon-capture additive. One particularly preferred application of this embodiment of the aqueous based copolymer emulsion composition is as a secondary metal ion battery additive, and more particularly as a secondary metal ion battery slurry composition for coating the battery anode or cathode.

### Methods of Making the ADAMS Copolymers for Use in Emulsion Compositions

The copolymers of functionalized styrenic monomers including a nitrogen-containing moiety, other than as pendant to the phenyl ring, for use in the novel aqueous based copolymer emulsion compositions disclosed herein, may be made by anionic polymerization processes.

Anionic polymerization processes which are absent of functionalized styrenic monomers including a nitrogen-containing moiety, other than as pendant to the phenyl ring, are generally known in the art, and are described for example in U.S. Pat. Nos. 5,736,612, 5,773,521, 8,604,136, and 9,809,671, which are herein incorporated by reference in their entirety. Anionic polymerization processes generally comprise at least the following steps:
(a) polymerizing one or more monomers in an inert hydrocarbon solvent in the presence of an alkyl lithium initiator until substantially complete conversion;
(b) optionally adding one or more sequential additions of one or more monomers, of the same or different composition, allowing each sequential addition of said monomers to polymerize until substantially complete conversion;
(c) optionally adding a polyfunctional coupling agent to couple some or all of the polymer or copolymer;
(d) adding a terminating agent.

Anionic polymerizations are generally initiated with alkyl lithium reagents, most frequently with sec-butyllithium, although other mono- and di-functional alkyl lithium initiators can be used. [Lintsell, et al., Synthesis and characterization of α, ω-and α-functionalized hydrogenated polybutadienes: telechelic and semi-telechelic amine and phosophite terminated polymers, Polymer, Vol. 38, Number 11, 2835 (1997)].

The monofunctional initiator which may be used may be an alkyl lithium, alkyl sodium, or alkyl potassium compound, generally in the C2 to C12 range. Alkyl lithium compounds such as methyllithium, ethyllithium, n-propyllithium, isopropylithium, n-butyllithium, iso-butyllithium, sec-butyllithium, tert-butyllithium, n-amyllithium, iso-amyllithium, sec-amyllithium, tert-amyllithium, hexyllithium, or a combination thereof, are preferred. Secondary alkyl lithium compounds, such as sec-butyllithium, sec-amyllithium, or a combination thereof, are more preferred. Most preferred is sec-butyllithium. Substituted alkyllithiums may also be used, such as aralkyllithium compounds, for example, benzyllithium, 1-lithioethylbenzene, and 1-lithio-3-methylpentylbenzene.

The difunctional initiator which may be used may be an alkyl dilithium, alkyl disodium, or alkyl dipotassium compound, generally in the C2 to C12 range, such as 1,3-propanediyldilithium, 1,4-butanediyldilithium, 1,5-pentanediyldilithium, 1,6-hexanedilyllithium, or a combination thereof. Additional difunctional initiators are disclosed in U.S. Pat. No. 6,492,469, which is herein incorporated by reference in its entirety.

The functionalized styrenic monomers including a nitrogen-containing moiety, other than as pendant to the phenyl ring, may be co-polymerized with isoprene, butadiene, styrene, and combinations thereof. Other non-limiting exemplary co-monomers that may be co-polymerized with the functionalized styrenic monomers including a nitrogen-containing moiety, other than as pendant to the phenyl ring, include various alkyl-substituted styrenes (i.e. 2-methylstyrene, 3-methylstyrene, 4-methylstyrene, 4-ethylstyrene, 4-n-butylstyrene, 4-tert-butylstyrene, 2,4-dimethylstyrene, 3,5-dimethylstyrene, 2,4,6-trimethylstyrene, 2,4-diethylstyrene, 3,5-diethylstyrene, 2,4-dipropylstyrene, 2-methyl-4-ethylstyrene, 2-methyl-4-propylstyrene, and the like), vinylnaphthalene, vinylpyridine, piperylene, methylpentyldiene.

The copolymers of functionalized styrenic monomers including a nitrogen-containing moiety, other than as pendant to the phenyl ring, for use in the novel aqueous based copolymer emulsion compositions disclosed herein, may be prepared via anionic polymerization process in which the monomers, or combinations thereof, are polymerized in solution in an inert hydrocarbon solvent in the presence of an alkyl lithium initiator. The inert hydrocarbon solvent may be any hydrocarbon, generally from 5 to 8 carbons, or mixtures thereof, which does not react with the alkyl lithium initiator or the ‘living’ anionic chain end of the polymer backbone, and offers appropriate solubility characteristics for the product polymer. Non-limiting examples of appropriate solvents are cyclic alkanes, such as cyclopentane, cyclohexane, cycloheptane, and cyclooctane, all of which are relatively non-polar. Other suitable solvents will be known to those skilled in the art and can be selected to perform effectively in a given set of process conditions, with polymerization temperature being one of the major factors taken into consideration.

The polymerization is preferably conducted in the presence of a polar additive that reduces the associations between the ions at the reactive ‘living’ anionic chain end of the polymer backbone, and thereby promotes polymerization. Non-limiting examples of the polar additives may include various ethers (i.e., dimethyl ether, diethyl ether, tetrahydrofuran, 2-methyl tetrahydrofuran, anisole 1,2-dimethoxyethane, 1,2-diethoxyethane, 1,2-dimethoxybenzene, 1-methoxy-2-(2-methoxyethoxy)ethane, and the like), various amines (i.e., trimethylamine, triethylamine, N,N,N′,N′-tetramethyl ethylene diamine, N,N,N′,N″,N″-pentamethyl diethylene triamine, and the like), or combinations thereof. Of the above polar additives, ethers are preferred.

Polymerization reaction conditions to prepare the the novel polymers of functionalized styrenic monomers including a nitrogen-containing moiety, other than as pendant to the phenyl ring, are typically similar to those used for anionic polymerizations in general. Depending on the monomers and the reaction solvent, the polymerization reaction may be carried out at a temperature of from about −80° C. to about 200° C., alternatively from about −40° C. to about 150° C., preferably from about 0° C. to about 100° C., and more preferably, from about 20° C. to about 90° C. In some examples, the polymerization of the functionalized monomers and copolymerization with other monomers and blocks can be carried out at room temperature, or alternatively from 15 to 70° C., alternatively from 20 to 60° C., alternatively from 25 to 50° C., or combinations of these aforementioned temperatures, or individual temperatures within such ranges.

The polymerization reaction is carried out under a dry, inert atmosphere, preferably nitrogen, and may also be carried out under pressure within the range of from about 0 bar to about 10 bar.

Upon completion of the polymerization reaction, a terminating agent may be added to stop the reaction, and quench the reactive ‘living’ anionic chain end of the polymer backbone. The polymerization terminating agent can be either various primary or secondary alcohols or an epoxide terminating agent. Non-limiting examples of the various primary or secondary alcohols include methanol, ethanol, isopropanol, 2-ethyl-1-hexanol, and the like, or a combination thereof. Non-limiting examples of the epoxide terminating agent include ethylene oxide, propylene oxide, butylene oxide, styrene oxide, methyl glycidyl ether, ethyl glycidyl ether, propyl glycidyl ether, butyl glycidyl ether, benzyl glycidyl ether, phenyl glycidyl ether, and the like, or a combination thereof. Of the polymerization terminating agents, methanol or isopropanol are preferred, except where one or more —OH functional groups at one or more termini of the polymer chain are desired, in which case, ethylene oxide or propylene oxide are preferred.

The copolymers of functionalized styrenic monomers including a nitrogen-containing moiety, other than as pendant to the phenyl ring, for use in the novel aqueous based copolymer emulsion compositions disclosed herein, may optionally be isolated or purified according to various general polymer isolation or purification techniques which are known in the art, for example, pouring the polymerization reaction solution into a poor solvent of the polymer, such as methanol, to solidify the polymers, or pouring the polymerization reaction solution into hot water together with steam to remove the solvent by azeotropy (steam stripping) and drying the resultant product.

Based on the difficulty of preparing and polymerizing these monomers, Applicant has explored other potential structures for functional monomers which are both simpler to manufacture and also polymerize. These functional monomer compositions containing aromatic structures containing at least one aminic nitrogen are described in commonly owned related U.S. Provisional Application Ser. No. 63/483,365 filed on Feb. 6, 2023, the contents of which are herein incorporated by reference in their entirety.

The inventive monomers disclosed in U.S. Provisional Application Ser. No. 63/483,365 have, to the best of the Applicant's knowledge, not been previously polymerized.

### Method of Making Aqueous Based Copolymer Emulsion Compositions

The present disclosure also relates to methods of making the aqueous based copolymer emulsion compositions disclosed herein.

In one embodiment, a method of making an aqueous based copolymer emulsion composition disclosed herein includes the steps of:
i) providing one or more copolymers comprising:
   (a) one or more amine-derivatized alpha-methyl styrene (ADAMS) repeat units according to structure (I):

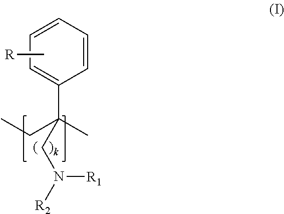

wherein:
   k is an integer from 1 to 3;
   R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof;
   R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof, and
   (b) one or more repeat units according to structures (II), (IIIₐ), (III_{b}), or combinations thereof

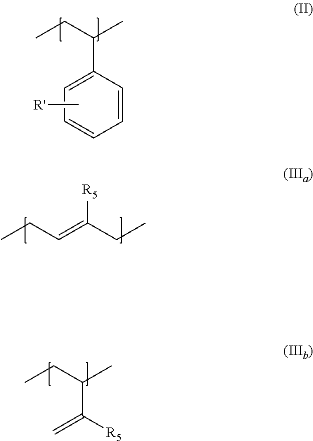

wherein:
   R₅ is a hydrogen or methyl group;
   R′ is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, and/or combinations thereof;
ii) dissolving the one or more copolymers into one or more organic solvents to form one or more dissolved copolymers;
iii) providing an aqueous surfactant solution including one or more surfactants selected from the group consisting of anionic surfactants, cationic surfactants, nonionic surfactants, amphoteric surfactants, and combinations thereof;
iv) combining and mixing the one or more dissolved copolymers and the aqueous surfactant solution;
v) further mixing the combined one or more dissolved copolymers and aqueous surfactant solution to form an emulsified mixture; and
vi) removing the one or more organic solvents from the emulsified mixture to form the aqueous based copolymer emulsion composition. For example, the one or more organic solvents may be removed in such a way as to prevent disruption (breaking or separation) of the aqueous-based copolymer emulsion to form the aqueous based copolymer emulsion composition. In one form, the one or one or more organic solvents may be removed from the emulsified mixture by stirring the mixed one or more dissolved copolymers and aqueous surfactant solution at a temperature of from 20 to 75 deg. C, or 25 to 70 deg. C, or 30 to 65 deg. C, or 35 to 60 deg. C, or 40 to 55 deg. C, and for a sufficient time to completely evaporate the one or more organic solvents to form the aqueous based copolymer emulsion composition.

In another embodiment, a method of making of making an aqueous based copolymer emulsion composition includes the steps of:
i) providing one or more copolymers comprising:
   (a) the reaction product of one or more monomers according to structure (VI)

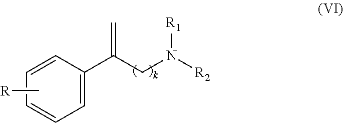

wherein:
   k is an integer from 1 to 3;
   R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof;
   R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof, and
   (b) the reaction product of one or more monomers according to structures (VII), (VIII), or combinations thereof

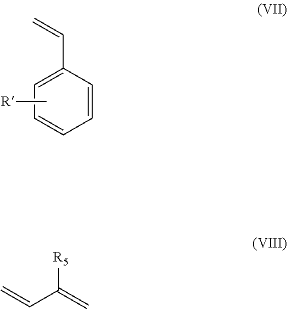

wherein:
   R₅ is a hydrogen or methyl group;
   R′ is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, and/or combinations thereof;
ii) dissolving the one or more copolymers into one or more organic solvents to form one or more dissolved copolymers;
iii) providing an aqueous surfactant solution including one or more surfactants selected from the group consisting of anionic surfactants, cationic surfactants, nonionic surfactants, amphoteric surfactants, and combinations thereof;
iv) combining and mixing the one or more dissolved copolymers and the aqueous surfactant solution;
v) further mixing the combined one or more dissolved copolymers and aqueous surfactant solution to form an emulsified mixture; and
vi) removing the one or more organic solvents from the emulsified mixture to form the aqueous based copolymer emulsion composition. In one form, the one or more organic solvents are removed in such a way as to prevent disruption (breaking or separation) of the aqueous-based copolymer emulsion. Such as for example, stirring the mixed one or more dissolved copolymers and aqueous surfactant solution at a temperature of from 20 to 75 deg. C, or 25 to 70 deg. C, or 30 to 65 deg. C, or 35 to 60 deg. C, or 40 to 55 deg. C, and for a sufficient time to completely evaporate the one or more organic solvents to form the aqueous based copolymer emulsion composition.

For the methods of making the aqueous based copolymer emulsion compositions disclosed above, a sufficient time may be a time to evaporate at least 95 wt %, or at least 98 wt. %, or at least 99 wt. %, or at least 99.5 wt. %, or at least 99.9 wt. %, or at least 99.99 wt. % of the one or more organic solvents. A sufficient time may be at least 15 minutes, or at least 30 minutes, or at least 45 minutes, or at least 60 minutes, or at least 75 minutes, or at least 90 minutes, or at least 105 minutes, or at least 120 minutes. The mixing step v) in the above methods may be done for example using probe sonication, high shear mixing, or a combination thereof. The mixing step v) may also be done for example using mixing tools or devices to create high shear force. Non-limiting examples of such devices to create high shear force are high shear mixers, ultrasonicators, high-power dispersers, and/or homogenizers

For the methods of making the aqueous based copolymer emulsion compositions disclosed above, the aqueous based copolymer emulsion compositions may include from 1 to 60 wt. % of one or more copolymers; from 0.05 to 5.0 wt. % of one or more surfactants selected from the group consisting of anionic surfactants, cationic surfactants, nonionic surfactants, amphoteric surfactants, and combinations thereof, and with the remainder of the composition comprising water.

For the steps of: ii) dissolving the one or more copolymers into one or more organic solvents to form one or more dissolved polymers, the one or more organic solvents may include, but are not limited to, cyclohexane, tetrahydrofuran, dichloromethane, toluene, benzene, xylene, heptane, isooctane, and combinations thereof. Other non-limiting organic solvents that function as emulsion solvents in the dissolving step ii) may include benzene, toluene, xylene, and ethylbenzene; halogenated hydrocarbons solvents such as dichloroethane, chloroform, and chlorobenzene; carbon tetrachloride; ketones such as methyl ethyl ketone, acetone, cyclohexanone, and cyclopentanone; esters such as methyl acetate, ethyl acetate, propyl acetate, and butyl acetate; higher alcohols such as diacetone alcohol and benzyl alcohol; ethers such as dioxane and tetrahydrofuran; nitriles such as acetonitrile, acrylonitrile, and propionitrile; and so on. Each of these organic or emulsion solvents may be used singly or in combination with each other.

For the steps of: vi) removing the one or more organic solvents from the emulsified mixture in such a way as to prevent disruption (breaking or separation) of the aqueous-based copolymer emulsion, the removal of the one or more organic solvents can be done at a temperature of 0 to 95° C., or 10 to 85° C., or 20 to 75° C., or 30 to 65° C., or 40 to 55° C., and at a pressure from 0 to 5 bar, or from 0.2 to 4 bar, or from 0.4 to 3 bar, or from 0.6 to 2 bar, or from 0.8 to 1 bar. The steps of removing the one or more organic solvents are done for a sufficient time to remove greater than 60 wt %, or greater than 80 wt %, or greater than 90 wt %, or greater than 95 wt %, or greater than 98 wt %, or greater than 99 wt % of the one or more organic solvents.

### Surfactants/Emulsifiers

Surfactants may also be referred to as emulsifiers or emulsifying agents herein and are used to disperse the one or more copolymers in the aqueous phase of the emulsion. The surfactants used herein are not particularly limited, and may include, for example, fatty acid soaps and rosin soaps. As specific examples of the fatty acid soaps, there can be sodium salts and potassium salts of a long chain fatty acid having 12 to 18 carbon atoms, such as lauric acid, myristic acid, palmitic acid, stearic acid, oleic acid or a mixed fatty acid thereof. As specific examples of the rosin soaps, there can be sodium salts and potassium salts of a disproportionated or hydrogenated product of natural rosin, such as gum rosin, wood rosin or tall oil rosin.

The surfactants used in the copolymer emulsion compositions disclosed herein may be classified as ionic, or non-ionic, and are preferably water soluble. Ionic surfactants or emulsifiers used herein may be anionic, cationic, or combinations thereof. A wide variety of surfactants may be used as emulsifying agents herein, including anionic surfactants, cationic surfactants, nonionic surfactants, amphoteric surfactants, and combinations thereof.

Preferred water-soluble emulsifiers are ionic surfactants or ionic emulsifiers. Anionic surfactants that may be used in in the copolymer emulsion compositions disclosed herein, may include alkali or ammonium soaps of resin acids and/or fatty acids, for instance of oleic acid, palmitic acid, stearic acid, lauric acid, myristic acid, arachic acid, ricinic acid. Other suitable anionic type surfactants are the alkali or ammonium soaps of branched carboxylic acids, of alkyl or arylsulphuric acids, of alky or arylsulphonic acids, as well as of sulphated or sulphonated glycidyl esters of carboxylic acids. Other examples of anionic surfactants or emulsifiers for use in the styrene-diene polymer emulsion compositions disclosed herein include, but are not limited to, anionic surface active agents such as higher alcohol sulfate esters, alkylbenzenesulfonate salts, aliphatic sulfonate salts, polyoxyethylene alkylarylsulfonate salts and polyphosphate salts. Other non-limiting exemplary anionic surfactants include soaps, turkey red oil, emulsifying oils, alkyl naphthalene sulfonates, dodecylbenzene sulfonate, oleate salts, alkylbenzene sulfonates, dialkyl sulfosuccinates, lignine sulfonate, alcohol ethoxysulfates, secondary alkanesulfonates, alpha-olefinsulfonic acids, and Tamol™. Still other exemplary anionic surfactants include fatty acids, e.g., myristic acid, palmitic acid, oleic acid, rinoleic acid, and salts thereof, alkylarylsulfonic acid salts, sulfuric acid esters of higher alcohols, alkyl sulfosuccinates, and combinations thereof. Still further other exemplary anionic surfactants are alkyl aryl sulfonates such as dodecyl benzene sodium sulfonate, dodecyl phenyl ether sodium sulfonate or the like; sulfosuccinate such as dioctyl sodium sulfosuccinate, dihexyl sodium sulfosuccinate or the like; salt of fatty acid such as sodium laurate or the like; ethoxy sulfate such as polyoxyethylene lauryl ether sodium sulfate or the like; alkane sulfonate; and alkyl ether sodium phosphate or the like.

Cationic surfactants that may be used in the copolymer emulsion compositions disclosed herein, may include aliphatic amine salts and quaternary ammonium salts thereof, aromatic quaternary ammonium salts, heterocyclic quaternary ammonium salts, and combinations thereof. Other, non-limiting exemplary cationic surfactants may include alkyl trimethyl ammonium salts, dialkyl dimethyl ammonium salts, alkyl pyrizinium salts, and alkyl benyl dimethyl ammonium salts. Still other exemplary cationic surfactants may include trimethyl ammonium chloride, dialkylammonium chloride, benzylammonium salt, quaternary ammonium salts, and combinations thereof.

Non-ionic surfactants that may be used in copolymer emulsion compositions disclosed herein, include, but are not limited to, polyoxyethylene alkyl ethers, polyoxyethylene alkyl aryl ethers, polyoxyethylene fatty acid esters, polyoxyethylene sorbitan fatty acid esters, polyoxyethylene oxypropylene block polymers, akylsulfinyl alcohols, fatty acid monoglycerides, and combinations thereof. Other exemplary non-ionic surfactants include polyoxyethylene alkyl ether, polyoxyethylene alkylphenol ether, polyoxyethylene alkyl ester, and polyoxyethylene sorbitan alkyl ester. The non-ionic surfactant is advantageously a polyoxyethyelen alkyl ether such as polyoxyethylene lauryl ether, polyoxyethylene cetyl ether, polyoxyetheylen stearyl ether or polyoxyethylene oleyl ether; polyoxyethylene alkyl aryl ether such as polyoxyethylene nonyl phenyl ether or polyoxyethylene octyl phenyl ether; polyethylene glycol fatty acid ester, polyethylene glycol phosphate; sorbitol fatty acid ester; fatty acid monglyceride; polyglycerine fatty acid ester; propyleneglycol fatty acid ester; cane sugar fatty acid ester, polyoxyethylene-polyoxypropylene block copolymer; polyoxyethylene-polyoxypropylene alkyl ether; ethylene oxide derivative of alkyl phenol formalin condensate; polyoxyethylene glycerine fatty acid ester, polyoxyethylene hardened castor oil; polyoxyethylene sorbitol fatty acid ester; fatty acid alkanolamide; polyoxyethylene fatty acid amide; and combinations thereof. The nonionic surfactant disclosed herein may be alternatively used with a water soluble polymer, such as, for example, polyethylene oxide (PEO), polyvinyl alcohol (PVA), carboxymethyl cellulose, polyacrylic acid, and combinations thereof.

Amphoteric surfactants that may be used in the copolymer emulsion compositions disclosed herein, may include, for example, carboxybetaine, sulfobetaine, aminocarboxylate salts, imidazoline derivatives, alkyl betaines, alkyl diethylenetriaminoacetates, and combinations thereof.

### Secondary Battery Electrode Slurry Compositions

Also provided herein are electrode slurry compositions for use in a secondary metal ion battery composition. The electrode slurry composition includes the aqueous based copolymer emulsion composition disclosed above and additionally includes one or more co-binders, one or more conductive carbon-based particles, and one or more of silicon based particles. The one or more conductive carbon-based particles may be selected from the group consisting of carbon nanotubes, graphite, and combinations thereof. The one or more of silicon based particles may be selected from the group consisting of silicon particles, silicon alloy particles, silica particles or combinations thereof.

The electrode slurry compositions for use in a secondary metal ion battery composition disclosed herein may improve the life of the secondary metal ion battery, but at least 1%, or at least 2%, or at least 3%, or at least 4%, or at least 5%, or at least 7%, or at least 10%, or at least 15%, or at least 20%. The electrode slurry compositions for use in a secondary metal ion battery composition disclosed herein may also improve the charge capacity retention of the secondary metal ion battery, but at least 1%, or at least 2%, or at least 3%, or at least 4%, or at least 5%, or at least 7%, or at least 10%, or at least 15%, or at least 20%.

### Co-Binders for Slurry Compositions

The electrode slurry compositions for use in a secondary metal ion battery composition disclosed herein include one or more co-binders. Non-limiting exemplary co-binders include polyacrylic acid (PAA), carboxymethyl cellulose (CMC), sodium alginate (SA), polyvinyl alcohol (PVA), chitosan (CS), polyacrylonitrile (PAN), polyimide (PI), gum arabic (GA), guar gum (GG), and combinations thereof. Other non-limiting exemplary co-binders include alginic acid and their various salts. Still other non-limiting exemplary co-binders include carboxy methyl cellulose (CMC)-based binders and its various salts (including but not limited to Na-CMC, Li-CMC, K-CMC, etc. and their mixtures may also be used as co-binders herein. In some designs, Li-salt of CMC may often be particularly favorable, and more particularly including those that additionally comprise elastic polymer nanoparticles, such as styrene butadiene rubber (SBR); polyacrylic acid (PAA) and their various salts (including but not limited to Na-PAA, Li-PAA, K-PAA, Ca-PAA and others and their mixtures. In some forms, Li-PAA salt may often be particularly favorable); (poly)alginic acid and various salts of (poly)alginic acid (Na-alginate, Li-alginate, Ca-alginate, K-alginate and many others and their various mixtures. In some forms, Li-alginate salt may often be particularly favorable) as well as maleic acid and their various salts (e.g., Li, Na, K, etc.). In other forms, Li-salt may often be particularly favorable), various (poly)acrylates (including, but not limited to dimethylaminoethyl acrylate and many others), various (poly)acrylamides, various polyesters, styrene butadiene rubber (SBR), (poly)ethylene oxide (PEO), (poly)vinyl alcohol (PVA), cyclodextrin, maleic anhydride, methacrylic acid and its various salts (Li, Na, K, etc.). In yet other forms, Li-salt may often be particularly favorable) as well as various (poly)ethylenimines (PEI), various (poly)amide imides (PAI), various (poly)amide amines, various other polyamine-based polymers, various (poly)ethyleneimines, sulfonic acid and their various salts, various catechol group-comprising polymers, various lignin-comprising or lignin-derived polymers, various epoxies, various cellulose-derived polymers (including, but not limited to nanocellulose fibers and nanocrystals, carboxyethyl cellulose, etc.), chitosan, other polymers (e.g., preferably water-soluble polymers) and their various co-polymers and mixtures thereof.

### Anode Active Materials (Carbon Based and Silicon Based Materials)

The electrode slurry compositions for use in a secondary metal ion battery composition disclosed herein include one or more active materials, such as for example, anode active materials. Active materials include carbon based active materials or particles, silicon based active materials or particles, and combinations thereof.

In one form, the electrode slurry compositions for use in a secondary metal ion battery composition disclosed herein include various carbon based active materials and/or silicon based active materials including, but not limited to, graphite, silicon, silicon oxide, silicon-graphene, silicon-aluminum alloy, tin/graphene, and various polymer binders (described above). Exemplary carbon based active materials include graphite, carbon nanotubes, and combinations thereof. In one form, the carbon based active material may have particle sizes of greater than equal to 10 μm, or greater than equal to 15 μm, or greater than equal to 20 μm, or greater than equal to 25 μm, or greater than equal to 30 μm, or greater than equal to 35 μm, or greater than equal to 40 μm, or greater than equal to 45 μm, or greater than equal to 50 μm. In another form, the carbon based active material may have particle sizes of less than equal to 10 μm, or less than equal to 8 μm, or less than equal to 6 μm, or less than equal to 4 μm, or less than equal to 2 μm, or less than equal to 1 μm, or less than equal to 0.5 μm. In yet another form, the carbon based active material may include a first carbon based active material, such as graphite, having particle sizes of more than about 10 μm, and a second carbon based active materials, such as graphite, having particles sizes of less than about 10 μm.

Exemplary silicon based active materials include silicon particles, silicon alloy particles, silica particles or combinations thereof. Silicon based materials may also include nanoparticles, nanowire and silicon/graphene composites. Silicon nanoparticle and nanowire anodes are expected to benefit from a fairly high binder loading (less than 15 wt %) and solvent in a wet electrode coating process because of the high surface area of these materials. One particularly advantageous anode active material for use in anodes is a combination of silicon and graphite to form a silicon/graphite composite. In another form, the silicon based active material may have particle sizes of greater than equal to 10 nm, or greater than equal to 15 nm, or greater than equal to 20 nm, or greater than equal to 25 nm, or greater than equal to 30 nm, or greater than equal to 35 nm, or greater than equal to 40 nm, or greater than equal to 45 nm, or greater than equal to 50 nm, or greater than equal to 60 nm, or greater than equal to 70 nm, or greater than equal to 80 nm, or greater than equal to 90 nm, or greater than equal to 100 nm, or greater than equal to 120 nm, or greater than equal to 140 nm, or greater than equal to 160 nm, or greater than equal to 180 nm, or greater than equal to 200 nm. In another form, the silicon based active material may have particle sizes of greater than equal to 100 μm, or greater than equal to 150 μm, or greater than equal to 200 μm, or greater than equal to 250 μm, or greater than equal to 300 μm, or greater than equal to 350 μm, or greater than equal to 400 μm, or greater than equal to 450 μm, or greater than equal to 500 μm.

The active materials and methods described herein may offer an advantage at higher silicon content in a composite anode electrode film, and may provide high energy density electrodes. A dry anode electrode film including a silicon/graphite composite anode active material as described herein may deliver electrochemical charge capacity comparable to its theoretical charge capacity. Thus, the silicon active materials in a dry silicon/graphite composite anode electrode film may be electrochemically active and accessible over a charge/discharge cycle.

### Method of Making Electrode Slurry Compositions

Also disclosed herein are methods of making an electrode slurry composition for a secondary metal ion battery, which includes the steps of: i. dispersing into an aqueous solution one or more conductive carbon-based particles, and one or more of silicon based particles; ii. mixing into the aqueous solution an aqueous based copolymer emulsion composition as described above; and iii. further mixing into the aqueous solution one or more co-binders to form the electrode slurry composition. As described above, the one or more conductive carbon-based particles may include, but are not limited to, of carbon nanotubes, graphites; and combinations thereof. Other conductive carbon-based particles as described above may also be utilized. As described above, the one more co-binders may include, but are not limited to, polyacrylic acid, carboxymethyl cellulose, hydroxyethyl cellulose, polyvinyl alcohol, polyurethane. Other co-binders as described above may also be utilized.

### Secondary Metal Ion Battery Anodes

Also disclosed herein are secondary metal ion battery anodes that include a copper foil substrate having a thickness of from 5 to 50 microns, or 10 to 45 microns; or 15 to 40 microns, or 20 to 35 microns, or 25 to 30 microns. The secondary metal ion battery anodes also include a continuous coating layer having a thickness of from 50 to 500 microns, or 100 to 450 microns; or 150 to 400 microns, or 200 to 350 microns, or 250 to 300 microns on one surface of the copper foil substrate.

The continuous coating layer includes from 10 to 80 wt. %, or 15 to 75 wt. %, or 20 to 70 wt. %, or 25 to 65 wt. %, or 30 to 60 wt. %, or 35 to 55 wt. %, or 40 to 50 wt. % of one or more conductive carbon-based particles; from 1 to 80 wt. %, or 5 to 75 wt. %, or 10 to 70 wt. %, 15 to 65 wt. %, or 20 to 60 wt. %, or 25 to 55 wt. %, or 30 to 50 wt. %, or 35 to 45 wt. % of one or more of silicon based particles; from 1 to 10 wt. %, or 2 to 8 wt. %, or 4 to 6 wt. % of one or more copolymer binders comprising:
(a) one or more amine-derivatized alpha-methyl styrene (ADAMS) repeat units according to structure (I):

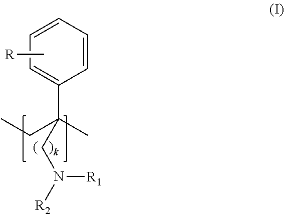

wherein:
k is an integer from 1 to 3;
R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof;
R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof, and
(b) one or more repeat units according to structures (II), (IIIₐ), (III_{b}), or combinations thereof

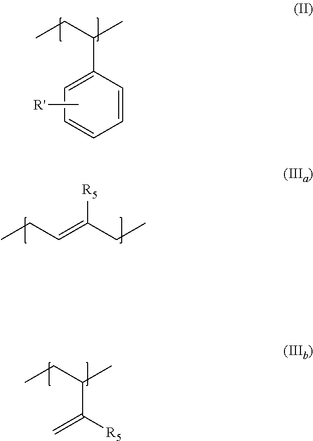

wherein:
R₅ is a hydrogen or methyl group;
R′ is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, and/or combinations thereof.

Alternatively, the continuous coating layer includes from 10 to 80 wt. %, or 15 to 75 wt. %, or 20 to 70 wt. %, or 25 to 65 wt. %, or 30 to 60 wt. %, or 35 to 55 wt. %, or 40 to 50 wt. % of one or more conductive carbon-based particles; from 1 to 80 wt. %, or 5 to 75 wt. %, or 10 to 70 wt. %, 15 to 65 wt. %, or 20 to 60 wt. %, or 25 to 55 wt. %, or 30 to 50 wt. %, or 35 to 45 wt. % of one or more of silicon based particles; from 1 to 10 wt. %, or 2 to 8 wt. %, or 4 to 6 wt. % of one or more copolymer binders comprising:
(a) the reaction product of one or more monomers according to structure (VI)

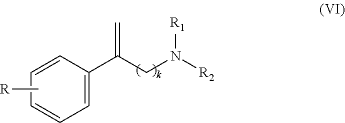

wherein:
   k is an integer from 1 to 3;
   R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof,
   R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof, and
   (b) the reaction product of one or more monomers according to structures (VII), (VIII), or combinations thereof

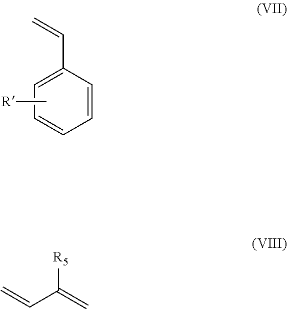

wherein:
   R₅ is a hydrogen or methyl group;
   R′ is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, and/or combinations thereof.

The secondary metal ion battery anodes disclosed herein also include in the continuous coating layer described above from 0 to 10 wt. %, or 1 to 8 wt. %, or 2 to 6 wt. % for 3 to 5 wt. % of one or more co-binders. As described above, the one or more conductive carbon-based particles may include, but are not limited to, of carbon nanotubes, graphites; and combinations thereof. Other conductive carbon-based particles as described above may also be utilized in the continuous coating layer of the anodes. As described above, the one more co-binders may include, but are not limited to, polyacrylic acid, carboxymethyl cellulose, hydroxyethyl cellulose, polyvinyl alcohol, polyurethane. Other co-binders as described above may also be utilized in the continuous coating layer of the anodes.

### Test Methods

Properties indicated in the Examples and the methods by which they are measured are as follows:

Unless specified otherwise, all reactions are performed in appropriately sized glass containers, equipped with magnetic stirring, and run inside a VAC OMNI-LAM inert atmosphere (e.g., N₂) glovebox. The atmosphere in the glovebox was maintained below 10 ppm oxygen and 0.2 ppm moisture.

All monomers used in the anionic polymerizations were purified in order to remove added stabilizers or adventitious moisture by using methods which would be familiar to those having ordinary skill in the art; either by distillation of the monomers, filtration of the monomers through basic aluminum oxide, or a combination of both.

During the polymerization reactions described below, a small quantity of initiator solution is added slowly dropwise to the reaction before the main portion of initiator solution. This ‘extra’ initiator is immediately consumed by residual stabilizers or adventitious moisture in the solvent or reactants, and the exact volume will be variable based on the efficacy of the monomer purification above. The ADAMS-derived ‘living’ anion responsible for the polymerization is a strong orange-red colour. Once enough initiator is added for a light-yellow colour to persist in the reaction mixture (indicating a very slight presence of ‘living’ anion), the reaction is judged to be free of inhibitor/moisture, and the target volume of initiator solution can be added.

Samples of each polymer were purified for analysis by polymer isolation techniques familiar to those skilled in the art, generally by slowly pouring a solution of the crude polymer into a poor solvent of the polymer, such as methanol, to solidify the polymers, followed by extensive drying under vacuum.

Gel permeation chromatography (GPC) samples were prepared on 3.0-5.0 ml scale by dissolving a sample of either the crude reaction mixture or the isolated polymer product, in stabilized tetrahydrofuran (THF) targeting a final sample concentration between 1.0-5.0 g polymer/ml THF. Samples were filtered through a PALL ACRODISC 0.45 μm wwPTFE filter, before being analyzed.

GPC was run using an AGILENT 1260 INFINITY II system, equipped with an AGILENT 1260 refractive index detector, and three AGILENT PLGEL 10 μm mixed-B chromatography columns maintained at 35° C. by the GPC column heater. Samples were run using a 50 μL injection volume, using stabilized THF (1.0 ml/min, isocratic) as the mobile phase, and a 405.0 min experiment run time.

GPC data analysis used AGILENT CIRUS GPC/SEC software, version 3.4.2.

The GPC was calibrated using WATERS ACQUITY APC polystyrene (PS) test kit standards between Mn=266-1,760,000 Da. All polymer Mn, Mw, Mz values are reported vs. PS standard, unless specified otherwise.

To prepare the NMR samples, ˜50-100 mg of the crude reaction mixture was added to a vial followed by 400 μL of benzene-d₆. The vial was sealed, mixed thoroughly until the sample had fully dissolved, and then transferred to an NMR tube. ¹H NMR spectra (16 scans) were recorded at 300 MHz with Bruker AVANCE™-300 instruments. Samples were prepared in benzene-d₆ and chemical shifts (6) are quoted in parts per million (ppm), referenced to TMS contained in the NMR solvent or, preferably, to the benzene-d₆ solvent peak calibrating the solvent singlet to 7.16 ppm.

Dynamic Light Scattering (DLS) measurements were used to measure the average size of the copolymer particles in the finished aqueous-based copolymer emulsions. Measurements were conducted on a WYATT DYNA-PRO NANOSTAR laser photometer, and analyses with WYATT DYNAMICS control software ver. 7.8.2.18. DLS samples were prepared by diluting the copolymer emulsion solutions prepared in Emulsion Examples 1-27 with distilled water to 100:1 relative to the finished copolymer emulsion solution, then filtering the diluted solutions through a PALL ACRODISC 0.45 μm wwPTFE filter. The particle sizes reported below are the are the average result of the cumulant fit of 6× acquisitions per sample.

This disclosure will be further understood by reference to the following (non-limiting) examples. In the Examples, all parts are parts by weight, unless otherwise noted.

### EXAMPLES

The amine functional groups present within the functional monomers used in the Examples below, are known or reasonably believed to interact with the stationary phase in standard GPC chromatography columns, and thereby shift the polymer retention times measured by chromatography system. As a result, there may be a significant source of error introduced to the molecular weight values reported by GPC (which are based on retention time within the GPC columns). The magnitude of this error may depend on the individual ADAMS monomer structure, the wt % content of the ADAMS repeat unit in the copolymer, the distribution of the ADAMS repeat units within the polymer backbone, or a combination thereof.

As a result of this potential source of error, included below in Table 1, are the calculated target number average molecular weight, Mn, for the polymers produced in Polymer Examples 1-27. These calculated values are based on the molar ratio between the monomers and the alkyl lithium initiator used in the reaction, according to Equation 1:

$$Mn = \frac{{n}_{monomer} \times {MW}_{unit}}{{n}_{initiator}} \qquad ( 1 )$$

where, nₘₒₙₒₘₑᵣ is the molar amount of the monomer present in the reaction in mol, nᵢₙᵢₜᵢₐₜₒᵣ is the molar amount of the alkyl lithium initiator present in the reaction in mol, and MWᵤₙᵢₜ is the molecular weight of the polymeric repeat unit (based on the monomers present in the reaction) in Da.

The calculated molecular weights in Table 1, are not corrected for comparison to a polystyrene standard. In cases where reaction monitoring by ¹H NMR has indicated that the ADAMS monomer forms a predominantly alternating copolymer structure with the comonomer (as evidenced by an approximately 1:1 molar consumption rate of both monomers, even where a large molar excess of one monomer may be present), the alternating ADAMS/comonomer polymer block is described as a separate block from the polymer block comprising the remaining comonomer. (See above). In such cases, the repeat unit within the ADAMS/comonomer block is considered to be the combined alternating structure, as in structures (IX), (Xₐ), and (X_{b}), with no additional comonomer repeat units present in ADAMS/comonomer block.

The reported GPC molecular weights in Table 1 are based on samples taken from the polymerization reaction either between subsequent additions of monomers, or of the final product polymer after isolation. As such, the molecular weights reported in Table 1 are cumulative molecular weights, which show the total polymer molecular weight at the completion of each polymer block sampled.

Polymer peaks were not visible by GPC for the alkylated ADAMS copolymers in Polymer Examples 25-27, due to their strong interactions with the stationary phase of the GPC columns.

The copolymer compositions, architectures, molecular weights, polydispersities, and coupling ratios from Polymer examples 1-17 are reported in Table 1. In Table 1, IP refers to isoprene, BD refers to 1,3-butadiene, and STY refers to styrene, PDI refers to the polydispersity index, and CR refers to the star polymer coupling ratio.

The copolymer emulsion compositions, surfactant loading, wt % solids, particle radius, and emulsion viscosity from Emulsion Examples 1-27 are reported in Table 2.

The emulsions were prepared using an IKA T25 ‘easy clean’ ULTRA-TURRAX high-shear mixer, equipped with an S25 EC-C-18G dispersing tool. The sonication steps used a QSONICA Q500 sonicator, equipped with a ¾″ solid sonicator probe, set to a pulse setting (cycling 20 s on, 10 s off) at 40% amplitude.

Dynamic viscosity of the polymer emulsions was measured using a ANTON PAAR VISCOQC 300 rotational viscometer, equipped with a RH2 rotor. Samples were run at a rotational speed of 100 rpm. Due to the low viscosity of the emulsions, the % torque readings were between 2.0-5.0% of the viscometer target range.

### Polymer Example 1

Into a 250 ml dry glass jar equipped with magnetic stirring was added 200 ml of anhydrous cyclohexane and 4.0 ml of anhydrous tetrahydrofuran, followed by 1.0 ml 1-(N-morpholinyl)-3-phenylbut-3-ene (4.5 mmol) and 36.0 ml isoprene (359.5 mmol). The solution was stirred for ˜1 min and a 0.1 ml aliquot of the solution was extracted for ¹H NMR. A small volume (typically between 0.05 to 0.20 ml) of a 1.12 M sec-butyl lithium solution in cyclohexane was slowly added dropwise to the reaction mixture until the solution turned a persistent light-yellow colour, after which an additional 0.45 ml of the 1.12 M sec-butyl lithium solution (0.50 mmol) was added in one portion.

The reaction was allowed to stir at room temperature and monitored regularly by extracting a ˜0.1 ml aliquot of the reaction mixture for ¹H NMR. When the reaction was judged to be substantially complete by ¹H NMR, 0.45 ml of isopropanol (5.9 mmol) was added to quench the reaction. The finished polymer solution in cyclohexane was used directly for the emulsification steps below.

### Polymer Example 2

The reaction was carried out according to the procedure for Polymer Polymer Example 1, except that 2.0 ml of 1-(N-morpholinyl)-3-phenylbut-3-ene (9.0 mmol) and 35.0 ml isoprene (349.5 mmol) were added instead.

### Polymer Example 3

The reaction was carried out according to the procedure for Polymer Polymer Example 1, except that 4.0 ml of 1-(N-morpholinyl)-3-phenylbut-3-ene (18.0 mmol) and 32.0 ml isoprene (319.5 mmol) were added instead.

### Polymer Example 4

The reaction was carried out according to the procedure for Polymer Polymer Example 1, except that 1.0 ml of 1-(4-methyl-1-piperazinyl)-3-phenylbut-3-ene (4.3 mmol) was used instead of 1-(N-morpholinyl)-3-phenylbut-3-ene.

### Polymer Example 5

The reaction was carried out according to the procedure for Polymer Polymer Example 1, except that 2.0 ml of 1-(4-methyl-1-piperazinyl)-3-phenylbut-3-ene (8.6 mmol) was used instead of 1-(N-morpholinyl)-3-phenylbut-3-ene, and 34.0 ml of isoprene (339.5 mmol) was added instead.

### Polymer Example 6

The reaction was carried out according to the procedure for Polymer Polymer Example 1, except that 4.0 ml of 1-(4-methyl-1-piperazinyl)-3-phenylbut-3-ene (17.1 mmol) was used instead of 1-(N-morpholinyl)-3-phenylbut-3-ene, and 32.0 ml of isoprene (319.5 mmol) was added instead.

### Polymer Example 7

The reaction was carried out according to the procedure for Polymer Polymer Example 1, except that 1.0 ml of 1-benzylmethylamino-3-phenylbut-3-ene (3.9 mmol) was used instead of 1-(N-morpholinyl)-3-phenylbut-3-ene, and 35.0 ml of isoprene (349.5 mmol) was added instead.

### Polymer Example 8

The reaction was carried out according to the procedure for Polymer Polymer Example 1, except that 2.0 ml of 1-benzylmethylamino-3-phenylbut-3-ene (7.8 mmol) was used instead of 1-(N-morpholinyl)-3-phenylbut-3-ene, and 35.0 ml of isoprene (349.5 mmol) was added instead.

### Polymer Example 9

The reaction was carried out according to the procedure for Polymer Polymer Example 1, except that 4.2 ml of 1-benzylmethylamino-3-phenylbut-3-ene (16.4 mmol) was used instead of 1-(N-morpholinyl)-3-phenylbut-3-ene, and 30.0 ml of isoprene (299.6 mmol) was added instead.

### Polymer Example 10

The reaction was carried out according to the procedure for Polymer Polymer Example 1, except that 1.0 ml of 1-(N-piperidinyl)-3-phenylbut-3-ene (4.6 mmol) was used instead of 1-(N-morpholinyl)-3-phenylbut-3-ene, and 36.0 ml of isoprene (359.5 mmol) was added instead.

### Polymer Example 11

The reaction was carried out according to the procedure for Polymer Polymer Example 1, except that 2.0 ml of 1-(N-piperidinyl)-3-phenylbut-3-ene (9.1 mmol) was used instead of 1-(N-morpholinyl)-3-phenylbut-3-ene, and 34.0 ml of isoprene (339.5 mmol) was added instead.

### Polymer Example 12

The reaction was carried out according to the procedure for Polymer Polymer Example 1, except that 4.0 ml of 1-(N-piperidinyl)-3-phenylbut-3-ene (18.2 mmol) was used instead of 1-(N-morpholinyl)-3-phenylbut-3-ene, and 32.0 ml of isoprene (319.5 mmol) was added instead.

### Polymer Example 13

The reaction was carried out according to the procedure for Polymer Polymer Example 1, except that 2.0 ml of 1-(N-morpholinyl)-3-phenylbut-3-ene (9.0 mmol), 16.0 ml isoprene (319.5 mmol), and 2.4 ml of 1.12 M sec-butyl lithium (2.7 mmol) were added instead. The reaction was quenched using 2.4 ml of isopropanol (31.4 mmol).

### Polymer Example 14

The reaction was carried out according to the procedure for Polymer Polymer Example 1, except that 4.0 ml of 1-(N-morpholinyl)-3-phenylbut-3-ene (18.0 mmol), 32.0 ml isoprene (319.5 mmol), and 0.15 ml of 1.12 M sec-butyl lithium (0.17 mmol) were added instead. The reaction was quenched using 2.4 ml of isopropanol (2.0 mmol).

### Polymer Example 15

The reaction was carried out according to the procedure for Polymer Polymer Example 1, except that 4.0 ml of 1-(N-morpholinyl)-3-phenylbut-3-ene (18.0 mmol), 32.0 ml isoprene (319.5 mmol), and 0.05 ml of 1.12 M sec-butyl lithium (0.06 mmol) were added instead. The reaction was quenched using 2.4 ml of isopropanol (0.7 mmol).

### Polymer Example 16

The reaction was carried out according to the procedure for Polymer Polymer Example 1, except that 8.0 ml of 1-(4-methyl-1-piperazinyl)-3-phenylbut-3-ene (34.2 mmol) was used instead of 1-(N-morpholinyl)-3-phenylbut-3-ene, and 26.0 ml of isoprene (259.6 mmol) was added instead.

### Polymer Example 17

The reaction was carried out according to the procedure for Polymer Polymer Example 1, except that 12.0 ml of 1-(4-methyl-1-piperazinyl)-3-phenylbut-3-ene (51.3 mmol) was used instead of 1-(N-morpholinyl)-3-phenylbut-3-ene, and 20.0 ml of isoprene (199.7 mmol) was added instead.

### Polymer Example 18

The reaction was carried out according to the procedure for Polymer Polymer Example 1, except that 16.0 ml of 1-(4-methyl-1-piperazinyl)-3-phenylbut-3-ene (68.4 mmol) was used instead of 1-(N-morpholinyl)-3-phenylbut-3-ene; 14.0 ml of isoprene (139.8 mmol) and 0.56 ml of 1.12 M sec-butyl lithium (0.62 mmol) were added instead.

### Polymer Example 19

The reaction was carried out according to the procedure for Polymer Polymer Example 1, except that 2.0 ml of 1-(N-piperidinyl)-3-phenylbut-3-ene (9.1 mmol) was used instead of 1-(N-morpholinyl)-3-phenylbut-3-ene, and 16.0 ml of isoprene (159.8 mmol) was added instead. Once the initial reaction was judged to be substantially complete by ¹H NMR, additional portions of 2.0 ml of 1-(N-piperidinyl)-3-phenylbut-3-ene (9.1 mmol) and 16.0 ml of isoprene (159.8 mmol) were added, and the reaction continued until the second stage of the reaction was judged to be complete by ¹H NMR.

### Polymer Example 20

The reaction was carried out according to the procedure for Polymer Polymer Example 1, except that 1.4 ml of 1-(N-piperidinyl)-3-phenylbut-3-ene (6.4 mmol) was used instead of 1-(N-morpholinyl)-3-phenylbut-3-ene, and 11.0 ml of isoprene (109.8 mmol) was added instead. Once the initial reaction was judged to be substantially complete by ¹H NMR, additional portions of 1.4 ml of 1-(N-piperidinyl)-3-phenylbut-3-ene (6.4 mmol) and 11.0 ml of isoprene (109.8 mmol) were added, and the reaction continued. Once the second stage of the reaction was judged to be substantially complete by ¹H NMR, further additional portions of 1.4 ml of 1-(N-piperidinyl)-3-phenylbut-3-ene (6.4 mmol) and 11.0 ml of isoprene (109.8 mmol) were added, and the reaction continued until the third stage of the reaction was judged to be complete by ¹H NMR.

### Polymer Example 21

The reaction was carried out according to the procedure for Polymer Polymer Example 1, except that 4.0 ml of 1-(N-piperidinyl)-3-phenylbut-3-ene (18.2 mmol) was used instead of 1-(N-morpholinyl)-3-phenylbut-3-ene, and 32.0 ml of isoprene (319.5 mmol) was added instead. Once the initial reaction was judged to be substantially complete by ¹H NMR, 0.45 ml of technical-grade divinylbenzene (55%, 1.7 mmol) was added, and the reaction continued for a further 1 h before it was quenched.

### Polymer Example 22

Into a 250 ml dry glass jar equipped with magnetic stirring was added 100 ml of anhydrous cyclohexane and 4.0 ml of anhydrous tetrahydrofuran, followed by 2.1 ml 1-benzylmethylamino-3-phenylbut-3-ene (8.2 mmol) and 100 ml of a 15% 1,3-butadiene solution in hexane (189.1 mmol). The solution was stirred for ˜1 min and a 0.1 ml aliquot of the solution was extracted for ¹H NMR. A small volume (typically between 0.5 to 1.5 ml) of a 1.12 M sec-butyl lithium solution in cyclohexane was slowly added dropwise to the reaction mixture until the solution turned a persistent light-yellow colour, after which an additional 1.0 ml of the 1.12 M sec-butyl lithium solution (1.1 mmol) was added in one portion.

The reaction was allowed to stir at room temperature and monitored regularly by extracting a ˜0.1 ml aliquot of the reaction mixture for ¹H NMR. When the reaction was judged to be substantially complete by ¹H NMR, 1.0 ml of isopropanol (13.1 mmol) was added to quench the reaction.

### Polymer Example 23

The reaction was carried out according to the procedure for Polymer Polymer Example 8, except that 4.0 ml of 1-benzylmethylamino-3-phenylbut-3-ene (156.6 mmol) was used instead of 1-(N-morpholinyl)-3-phenylbut-3-ene, 26.0 ml of styrene (227.1 mmol) was used instead of isoprene, and 1.0 ml of 1.12 M sec-butyl lithium (1.1 mmol) was added instead.

### Polymer Example 24

The reaction was carried out according to the procedure for Polymer Polymer Example 8, except that 4.0 ml of 1-benzylmethylamino-3-phenylbut-3-ene (15.6 mmol) was used instead of 1-(N-morpholinyl)-3-phenylbut-3-ene, and 18.0 ml of isoprene (179.7 mmol) was added instead. Once the initial reaction was judged to be substantially complete by ¹H NMR, an additional portion of 10.0 ml of styrene (87.3 mmol) was added, and the reaction continued until the second stage of the reaction was judged to be complete by ¹H NMR.

### Polymer Example 25

In a 250 ml round bottom flask equipped with magnetic stirring water-cooled condenser, under N₂ atmosphere, 6.0 g of the isolated polymer from Polymer Example 10 (approx. 3.9 wt % ADAMS repeat units), was dissolved in 80 ml of stabilized tetrahydrofuran. To the solution, 0.14 ml of benzyl bromide (1.2 mmol, 1.1 mol eq. vs. ADAMS repeat units) was added, followed by heating the solution to 65° C. for 6 h. The reaction was allowed to cool, and the polymer solution used directly for the emulsification step without further purification. A small aliquot of the solution was evaporated under reduced pressure for GPC analysis.

### Polymer Example 26

The sample was prepared according to the procedure in Polymer Example 25, except that the isolated polymer from Polymer Example 11 (approx. 7.8 wt % ADAMS repeat units) was used instead of that from Polymer Example 10, and 0.29 ml of benzyl bromide (2.4 mmol, 1.1 mol eq. vs. ADAMS repeat units) was added instead.

### Polymer Example 27

The sample was prepared according to the procedure in Polymer Example 25, except that the isolated polymer from Polymer Example 12 (approx. 15.3 wt % ADAMS repeat units) was used instead of that from Polymer Example 10, and 0.56 ml of benzyl bromide (4.7 mmol, 1.1 mol eq. vs. ADAMS repeat units) was added instead.

### Polymer Example 28

In a pressure reactor, 1.1 g of the isolated polymer from Polymer Example 1 was dissolved in 100 ml of cyclohexane followed by addition of 0.2 g of rhodium (I) tris(triphenylphosphine) chloride. The reactor was then sealed and first purged with N₂ gas, followed by purging with hydrogen gas. The reaction solution was heated to 140° C. under a pressure of 425 psi of hydrogen gas for 4 h, before being cooled and the reactor opened. The residual catalyst was removed by filtering the product solution through a pad activated carbon (NORIT AS5) and CELITE 545, and the polymer solution filtrate was then concentrated under reduced pressure. ¹H NMR analysis showed a 85% reduction in alkene C—H bonds between 4.0-6.0 ppm, when compared to the morpholine group CH₂—O peak at ˜3.8 ppm.

TABLE 1
Polymer Examples

| | | | | | | | | | | | |
|---|---|---|---|---|---|---|---|---|---|---|---|
| | | | | | | | Calculated | GPC total | GPC total | | |
| | | | | | | | total Mn | Mn (kDa, | Mw (kDa, | | |
| | | | | ADAMS | Block | Block | (kDa, | vs. PS | vs. PS | GPC | |
| Ex. | Architecture | ADAMS monomer | Comonomer | wt % | # | Composition | uncorrected) | standard) | standard) | PDI | CR |

| | | | | | | | | |
|---|---|---|---|---|---|---|---|---|
| 1 | diblock | 1-(N-morpholinyl)- | Isoprene | 3.8% | 1 | ADAMS/IP | 2.5 | not isolated |
| | | 3-phenylbut-3-ene | | | | (alternating) | | |

| | | | | | |
|---|---|---|---|---|---|
| 2 | Isoprene | 50.5 | 77.5 | 82.6 | 1.07 |

| | | | | | | | | |
|---|---|---|---|---|---|---|---|---|
| 2 | diblock | 1-(N-morpholinyl)- | Isoprene | 7.6% | 1 | ADAMS/IP | 5.1 | not isolated |
| | | 3-phenylbut-3-ene | | | | (alternating) | | |

| | | | | | |
|---|---|---|---|---|---|
| 2 | Isoprene | 51.1 | 90.7 | 99.8 | 1.10 |

| | | | | | | | | |
|---|---|---|---|---|---|---|---|---|
| 3 | diblock | 1-(N-morpholinyl)- | Isoprene | 15% | 1 | ADAMS/IP | 10.2 | not isolated |
| | | 3-phenylbut-3-ene | | | | (alternating) | | |

| | | | | | |
|---|---|---|---|---|---|
| 2 | Isoprene | 51.0 | 100.7 | 122.2 | 1.21 |

| | | | | | | | | |
|---|---|---|---|---|---|---|---|---|
| 4 | diblock | 1-(4-methyl-1- | Isoprene | 3.9% | 1 | ADAMS/IP | 2.5 | not isolated |
| | | piperazinyl)-3- | | | | (alternating) | | |

| | | | | | | |
|---|---|---|---|---|---|---|
| phenylbut-3-ene | 2 | Isoprene | 50.5 | 86.8 | 92.9 | 1.07 |

| | | | | | | | | |
|---|---|---|---|---|---|---|---|---|
| 5 | diblock | 1-(4-methyl-1- | Isoprene | 7.9% | 1 | ADAMS/IP | 5.1 | not isolated |
| | | piperazinyl)-3- | | | | (alternating) | | |

| | | | | | | |
|---|---|---|---|---|---|---|
| phenylbut-3-ene | 2 | Isoprene | 49.8 | 90.2 | 97.5 | 1.08 |

| | | | | | | | | |
|---|---|---|---|---|---|---|---|---|
| 6 | diblock | 1-(4-methyl-1- | Isoprene | 15% | 1 | ADAMS/IP | 10.1 | not isolated |
| | | piperazinyl)-3- | | | | (alternating) | | |

| | | | | | | |
|---|---|---|---|---|---|---|
| phenylbut-3-ene | 2 | Isoprene | 51.0 | 89.6 | 98.3 | 1.10 |

| | | | | | | | | |
|---|---|---|---|---|---|---|---|---|
| 7 | diblock | 1-benzylmethylamino- | Isoprene | 4.0% | 1 | ADAMS/IP | 2.5 | not isolated |
| | | 3-phenylbut-3-ene | | | | (alternating) | | |

| | | | | | |
|---|---|---|---|---|---|
| 2 | Isoprene | 49.2 | 72.4 | 77.3 | 1.07 |

| | | | | | | | | |
|---|---|---|---|---|---|---|---|---|
| 8 | diblock | 1-benzylmethylamino- | Isoprene | 7.6% | 1 | ADAMS/IP | 4.9 | not isolated |
| | | 3-phenylbut-3-ene | | | | (alternating) | | |

| | | | | | |
|---|---|---|---|---|---|
| 2 | Isoprene | 51.1 | 73.3 | 78.9 | 1.08 |

| | | | | | | | | |
|---|---|---|---|---|---|---|---|---|
| 9 | diblock | 1-benzylmethylamino- | Isoprene | 17% | 1 | ADAMS/IP | 10.4 | not isolated |
| | | 3-phenylbut-3-ene | | | | (alternating) | | |

| | | | | | |
|---|---|---|---|---|---|
| 2 | Isoprene | 48.6 | 65.4 | 71.3 | 1.09 |

| | | | | | | | | |
|---|---|---|---|---|---|---|---|---|
| 10 | diblock | 1-(N-piperidinyl)- | Isoprene | 3.9% | 1 | ADAMS/IP | 2.6 | not isolated |
| | | 3-phenylbut-3-ene | | | | (alternating) | | |

| | | | | | |
|---|---|---|---|---|---|
| 2 | Isoprene | 50.5 | 79.9 | 86.4 | 1.08 |

| | | | | | | | | |
|---|---|---|---|---|---|---|---|---|
| 11 | diblock | 1-(N-piperidinyl)- | Isoprene | 7.8% | 1 | ADAMS/IP | 5.2 | not isolated |
| | | 3-phenylbut-3-ene | | | | (alternating) | | |

| | | | | | |
|---|---|---|---|---|---|
| 2 | Isoprene | 49.8 | 74.6 | 80.9 | 1.08 |

| | | | | | | | | |
|---|---|---|---|---|---|---|---|---|
| 12 | diblock | 1-(N-piperidinyl)- | Isoprene | 15% | 1 | ADAMS/IP | 10.2 | not isolated |
| | | 3-phenylbut-3-ene | | | | (alternating) | | |

| | | | | | |
|---|---|---|---|---|---|
| 2 | Isoprene | 51.0 | 69.0 | 76.9 | 1.11 |

| | | | | | | | | |
|---|---|---|---|---|---|---|---|---|
| 13 | diblock | 1-(N-morpholinyl)- | Isoprene | 15% | 1 | ADAMS/IP | 1.0 | not isolated |
| | | 3-phenylbut-3-ene | | | | (alternating) | | |

| | | | | | |
|---|---|---|---|---|---|
| 2 | Isoprene | 4.8 | 5.9 | 6.6 | 1.12 |

| | | | | | | | | |
|---|---|---|---|---|---|---|---|---|
| 14 | diblock | 1-(N-morpholinyl)- | Isoprene | 15% | 1 | ADAMS/IP | 30.6 | not isolated |
| | | 3-phenylbut-3-ene | | | | (alternating) | | |

| | | | | | |
|---|---|---|---|---|---|
| 2 | Isoprene | 152.8 | 249.0 | 279.8 | 1.12 |

| | | | | | | | | |
|---|---|---|---|---|---|---|---|---|
| 15 | diblock | 1-(N-morpholinyl)- | Isoprene | 15% | 1 | ADAMS/IP | 91.9 | not isolated |
| | | 3-phenylbut-3-ene | | | | (alternating) | | |

| | | | | | |
|---|---|---|---|---|---|
| 2 | Isoprene | 458.6 | 473.0 | 778.1 | 1.65 |

| | | | | | | | | |
|---|---|---|---|---|---|---|---|---|
| 16 | diblock | 1-(4-methyl-1- | Isoprene | 31% | 1 | ADAMS/IP | 20.2 | not isolated |
| | | piperazinyl)-3- | | | | (alternating) | | |

| | | | | | | |
|---|---|---|---|---|---|---|
| phenylbut-3-ene | 2 | Isoprene | 50.7 | 58.4 | 66.5 | 1.14 |

| | | | | | | | | |
|---|---|---|---|---|---|---|---|---|
| 17 | diblock | 1-(4-methyl-1- | Isoprene | 47% | 1 | ADAMS/IP | 30.3 | not isolated |
| | | piperazinyl)-3- | | | | (alternating) | | |

| | | | | | | |
|---|---|---|---|---|---|---|
| phenylbut-3-ene | 2 | Isoprene | 50.4 | 45.9 | 59.9 | 1.31 |

| | | | | | | | | |
|---|---|---|---|---|---|---|---|---|
| 18 | diblock | 1-(4-methyl-1- | Isoprene | 62% | 1 | ADAMS/IP | 32.5 | not isolated |
| | | piperazinyl)-3- | | | | (alternating) | | |

| | | | | | | |
|---|---|---|---|---|---|---|
| phenylbut-3-ene | 2 | Isoprene | 40.3 | 20.0 | 25.6 | 1.28 |

| | | | | | | | | |
|---|---|---|---|---|---|---|---|---|
| 19 | tetrablock | 1-(N-piperidinyl)- | Isoprene | 15% | 1 | ADAMS/IP | 5.1 | not isolated |
| | | 3-phenylbut-3-ene | | | | (alternating) | | |

| 2 | Isoprene | 25.5 | 26.8 | 31.1 | 1.16 |
|---|---|---|---|---|---|
| 3 | ADAMS/IP | 30.6 | not isolated | | |
| | (alternating) | | | | |
| 4 | Isoprene | 50.9 | 51.4 | 60.0 | 1.17 |

| | | | | | | | | |
|---|---|---|---|---|---|---|---|---|
| 20 | hexablock | 1-(N-piperidinyl)- | Isoprene | 15% | 1 | ADAMS/IP | 3.6 | not isolated |
| | | 3-phenylbut-3-ene | | | | (alternating) | | |

| 2 | Isoprene | 17.6 | 19.0 | 23.0 | 1.21 |
|---|---|---|---|---|---|
| 3 | ADAMS/IP | 21.1 | not isolated | | |
| | (alternating) | | | | |
| 4 | Isoprene | 35.1 | 36.5 | 43.4 | 1.19 |
| 5 | ADAMS/IP | 38.7 | not isolated | | |
| | (alternating) | | | | |
| 6 | Isoprene | 52.7 | 53.4 | 63.8 | 1.19 |

| | | | | | | | | |
|---|---|---|---|---|---|---|---|---|
| 21 | diblock-star | 1-(N-piperidinyl)- | Isoprene | 15% | 1 | ADAMS/IP | 10.2 | not isolated |
| | | 3-phenylbut-3-ene | | | | (alternating) | | |

| | | | | | | |
|---|---|---|---|---|---|---|
| 2 | Isoprene | 50.9 | 54.4 | 61.2 | 1.13 | |
| star | DVB | | 275.3 | 311.7 | 1.13 | 60% |

| | | | | | | | | |
|---|---|---|---|---|---|---|---|---|
| 22 | diblock | 1-benzylmethylamino- | 1,3- | 17% | 1 | ADAMS/BD | 2.2 | not isolated |
| | | 3-phenylbut-3-ene | Butadiene | | | (alternating) | | |

| | | | | | |
|---|---|---|---|---|---|
| 2 | 1,3-Butadiene | 11.0 | 9.4 | 10.0 | 1.06 |

| | | | | | | | | |
|---|---|---|---|---|---|---|---|---|
| 23 | diblock | 1-benzylmethylamino- | Styrene | 14% | 1 | ADAMS/STY | 5.0 | not isolated |
| | | 3-phenylbut-3-ene | | | | (random) | | |

| | | | | | |
|---|---|---|---|---|---|
| 2 | Styrene | 24.6 | 21.9 | 25.8 | 1.18 |

| | | | | | | | | |
|---|---|---|---|---|---|---|---|---|
| 24 | Triblock | 1-benzylmethylamino- | Styrene + | 16% | 1 | ADAMS/IP | 9.9 | not isolated |
| | | 3-phenylbut-3-ene | Isoprene | | | (alternating) | | |

| | | | | | |
|---|---|---|---|---|---|
| 2 | Isoprene | 32.0 | 37.2 | 40.4 | 1.09 |
| 3 | Styrene | 50.1 | 50.1 | 56.2 | 1.12 |

| | | | | | | | | |
|---|---|---|---|---|---|---|---|---|
| 25 | diblock | 1-(N-piperidinyl)- | Isoprene | 3.9% | 1 | ADAMS/IP | 2.6 | not isolated |
| | (alkylated) | 3-phenylbut-3-ene | | | | (alternating) | | |
| | | | | | 2 | Isoprene | 50.5 | no peak by GPC |
| 26 | diblock | 1-(N-piperidinyl)- | Isoprene | 7.8% | 1 | ADAMS/IP | 5.2 | not isolated |
| | (alkylated) | 3-phenylbut-3-ene | | | | (alternating) | | |
| | | | | | 2 | Isoprene | 49.8 | no peak by GPC |
| 27 | diblock | 1-(N-piperidinyl)- | Isoprene | 15% | 1 | ADAMS/IP | 10.2 | not isolated |
| | (alkylated) | 3-phenylbut-3-ene | | | | (alternating) | | |
| | | | | | 2 | Isoprene | 51.0 | no peak by GPC |
| 28 | diblock | 1-(N-morpholinyl)- | Isoprene | 3.8% | 1 | ADAMS/IP | 2.5 | not isolated |
| | (hydrogenated) | 3-phenylbut-3-ene | | | | (alternating) | | |
| | | | | | 2 | Isoprene | 50.5 | not analyzed by GPC |

### Emulsion Example 1

0.01 g of 2,4-di-tert-buty-4-methylphenol (BHT) was added to 80 g of the polymer solution prepared in Polymer Example 1 (approx. 14 wt % polymer in cyclohexane) which was then further diluted with 90 g of tetrahydrofuran and stirred at room temperature for 30 minutes. A solution of 2.8 g sodium dodecyl sulfate (9.7 mmol) in 280 g of distilled water was prepared concurrently and added to the polymer solution once mixing was complete. A crude polymer emulsion was prepared from the biphasic solution by mixing with a high-shear mixer starting at 3000 rpm, ramping the speed to 11,000 rpm over 1-2 minutes, and further mixing at 11,000 rpm for 30 minutes. The crude polymer emulsion was then sonicated using the above conditions for 30 minutes. The finished polymer emulsion solution was mixed in an open 1 L beaker with magnetic stirring for 1 to 4 days until the organic solvents had fully evaporated. The polymer emulsion was filtered through cotton cheese cloth to remove any precipitated polymer. The emulsion was analyzed by DLS and solids content measured by gravimetric analysis on a dried sample. Results are shown in Table 2 below.

### Emulsion Example 2

The emulsion was prepared in the same way as Emulsion Example 1, except that the polymer solution prepared in Polymer Example 2 was used instead of that from Polymer Example 1.

### Emulsion Example 3

The emulsion was prepared in the same way as Emulsion Example 1, except that the polymer solution prepared in Polymer Example 3 was used instead of that from Polymer Example 1.

### Emulsion Example 4

The emulsion was prepared in the same way as Emulsion Example 1, except that the polymer solution prepared in Polymer Example 4 was used instead of that from Polymer Example 1.

### Emulsion Example 5

The emulsion was prepared in the same way as Emulsion Example 1, except that the polymer solution prepared in Polymer Example 5 was used instead of that from Polymer Example 1.

### Emulsion Example 6

The emulsion was prepared in the same way as Emulsion Example 1, except that the polymer solution prepared in Polymer Example 6 was used instead of that from Polymer Example 1.

### Emulsion Example 7

The emulsion was prepared in the same way as Emulsion Example 1, except that the polymer solution prepared in Polymer Example 7 was used instead of that from Polymer Example 1.

### Emulsion Example 8

The emulsion was prepared in the same way as Emulsion Example 1, except that the polymer solution prepared in Polymer Example 8 was used instead of that from Polymer Example 1.

### Emulsion Example 9

The emulsion was prepared in the same way as Emulsion Example 1, except that the polymer solution prepared in Polymer Example 9 was used instead of that from Polymer Example 1.

### Emulsion Example 10

The emulsion was prepared in the same way as Emulsion Example 1, except that the polymer solution prepared in Polymer Example 10 was used instead of that from Polymer Example 1.

### Emulsion Example 11

The emulsion was prepared in the same way as Emulsion Example 1, except that the polymer solution prepared in Polymer Example 11 was used instead of that from Polymer Example 1.

### Emulsion Example 12

The emulsion was prepared in the same way as Emulsion Example 1, except that the polymer solution prepared in Polymer Example 12 was used instead of that from Polymer Example 1.

### Emulsion Example 13

The emulsion was prepared in the same way as Emulsion Example 1, except that the polymer solution prepared in Polymer Example 13 (approx. 8 wt % polymer in cyclohexane) was used instead of that from Polymer Example 1, and the following reagent amounts were used instead: 51 g of tetrahydrofuran, 0.003 g of BHT, 1.6 g sodium dodecylsulfate (5.5.mmol), and 160 g of distilled water.

### Emulsion Example 14

The emulsion was prepared in the same way as Emulsion Example 1, except that the polymer solution prepared in Polymer Example 14 was used instead of that from Polymer Example 1.

### Emulsion Example 15

The emulsion was prepared in the same way as Emulsion Example 1, except that the polymer solution prepared in Polymer Example 15 was used instead of that from Polymer Example 1.

### Emulsion Example 16

The emulsion was prepared in the same way as Emulsion Example 1, except that the polymer solution prepared in Polymer Example 16 was used instead of that from Polymer Example 1, and an additional 60 g of cyclohexane was added to the polymer solution prior to mixing.

### Emulsion Example 17

The emulsion was prepared in the same way as Emulsion Example 1, except that the polymer solution prepared in Polymer Example 17 was used instead of that from Polymer Example 1, and an additional 60 g of cyclohexane was added to the polymer solution prior to mixing.

### Emulsion Example 18

The emulsion was prepared in the same way as Emulsion Example 1, except that the polymer solution prepared in Polymer Example 18 was used instead of that from Polymer Example 1, and an additional 60 g of cyclohexane was added to the polymer solution prior to mixing.

### Emulsion Example 19

The emulsion was prepared in the same way as Emulsion Example 1, except that the polymer solution prepared in Polymer Example 19 was used instead of that from Polymer Example 1, and an additional 60 g of cyclohexane was added to the polymer solution prior to mixing.

### Emulsion Example 20

The emulsion was prepared in the same way as Emulsion Example 1, except that the polymer solution prepared in Polymer Example 20 was used instead of that from Polymer Example 1, and an additional 60 g of cyclohexane was added to the polymer solution prior to mixing.

### Emulsion Example 21

The emulsion was prepared in the same way as Emulsion Example 1, except that the polymer solution prepared in Polymer Example 21 was used instead of that from Polymer Example 1, and an additional 60 g of cyclohexane was added to the polymer solution prior to mixing.

### Emulsion Example 22

The emulsion was prepared in the same way as Emulsion Example 1, except that the polymer solution prepared in Polymer Example 22 was used instead of that from Polymer Example 1.

### Emulsion Example 23

The emulsion was prepared in the same way as Emulsion Example 1, except that the polymer solution prepared in Polymer Example 23 was used instead of that from Polymer Example 1.

### Emulsion Example 24

The emulsion was prepared in the same way as Emulsion Example 1, except that the polymer solution prepared in Polymer Example 24 was used instead of that from Polymer Example 1.

### Emulsion Example 25

The emulsion was prepared in the same way as Emulsion Example 1, except that the polymer solution prepared in Polymer Example 25 was used instead of that from Polymer Example 1, and the polymer solution was diluted with 70 g of cyclohexane instead of tetrahydrofuran.

### Emulsion Example 26

The emulsion was prepared in the same way as Emulsion Example 1, except that the polymer solution prepared in Polymer Example 26 was used instead of that from Polymer Example 1, and the polymer solution was diluted with 70 g of cyclohexane instead of tetrahydrofuran.

### Emulsion Example 27

The emulsion was prepared in the same way as Emulsion Example 1, except that the polymer solution prepared in Polymer Example 27 was used instead of that from Polymer Example 1, and the polymer solution was diluted with 70 g of cyclohexane instead of tetrahydrofuran.

TABLE 2
Emulsion Examples

| Emulsion | Surf. | wt % | Particle | Radius ± | Dynamic |
|---|---|---|---|---|---|
| Example | wt % | Solids | Radius (nm) | Error (nm) | Viscosity (cP) |
| 1 | 1.0% | 6.4% | 28.7 | 1.9 | 12.79 |
| 2 | 1.0% | 6.9% | 26.5 | 2.0 | 13.19 |
| 3 | 1.0% | 6.4% | 30.4 | 0.4 | 13.59 |
| 4 | 1.0% | 5.7% | 25.5 | 1.1 | 13.59 |
| 5 | 1.0% | 5.6% | 22.1 | 0.5 | 12.79 |
| 6 | 1.0% | 5.5% | 25.9 | 1.1 | 12.79 |
| 7 | 1.0% | 4.6% | 16.2 | 0.3 | 12.4 |
| 8 | 1.0% | 5.5% | 15.8 | 0.3 | 12.79 |
| 9 | 1.0% | 4.9% | 16.1 | 0.3 | 13.19 |
| 10 | 1.0% | 5.2% | 21.5 | 0.8 | 12.79 |
| 11 | 1.0% | 5.1% | 24.5 | 0.6 | 12.79 |
| 12 | 1.0% | 5.3% | 26.7 | 0.5 | 12.4 |
| 13 | 1.0% | 5.3% | 25.7 | 1.0 | 9.946 |
| 14 | 1.0% | 5.5% | 27.0 | 2.3 | 13.19 |
| 15 | 1.0% | 5.0% | 64.5 | 1.9 | 13.19 |
| 16 | 1.0% | 7.6% | 9.0 | 0.3 | 17.99 |
| 17 | 1.0% | 6.4% | 17.8 | 0.5 | 15.59 |
| 18 | 1.0% | 6.1% | 18.8 | 1.3 | 15.99 |
| 19 | 1.0% | 5.0% | 27.9 | 1.2 | 12.79 |
| 20 | 1.0% | 5.1% | 32.1 | 2.3 | 12.79 |
| 21 | 1.0% | 5.2% | 34.5 | 2.9 | 13.19 |
| 22 | 1.0% | 3.4% | 23.5 | 0.2 | 12.40 |
| 23 | 1.0% | 5.1% | 24.4 | 0.9 | 12.79 |
| 24 | 1.0% | 5.1% | 23.0 | 1.1 | 12.40 |
| 25 | 1.0% | 5.2% | 30.3 | 2 | 8.40 |
| 26 | 1.0% | 5.2% | 10.8 | 0.4 | 2.60 |
| 27 | 1.0% | 6.0% | 51.9 | 1.6 | 4.40 |

All documents described herein are incorporated by reference herein, including any priority documents and/or testing procedures, to the extent they are not inconsistent with this text. As should be apparent from the foregoing general description and the specific embodiments, while forms of the invention have been illustrated and described, various modifications can be made without departing from the spirit and scope of the invention. Accordingly, it is not intended that the invention be limited thereby. The term “comprising” specifies the presence of stated features, steps, integers, or components, but does not preclude the presence or addition of one or more other features, steps, integers, components, or groups thereof. As such, the term “comprising” is considered essentially synonymous with the term “including.” Similarly, whenever a composition, an element, or a group of elements is preceded with the transitional phrase “comprising,” it should be understood that the same composition or group of elements is contemplated with transitional phrases “consisting essentially of,” “consisting of,” “selected from the group of consisting of,” or “can be”/“may be”/“is” preceding the recitation of the composition, element, or elements, and vice versa. In juxtaposition to the well-known terms “comprising” meaning “including what follows and anything else” [open] and “consisting of” meaning “including only what follows” [closed], the term “consisting essentially of” should be understood to be semi-inclusive and to mean, in accordance with US judicial interpretation, including that which follows and other things that do not materially affect the basic and novel properties.

Applicants have attempted to disclose all embodiments and applications of the disclosed subject matter that could be reasonably foreseen. However, there may be unforeseeable, insubstantial modifications that remain as equivalents. While the present invention has been described in conjunction with specific, exemplary embodiments thereof, it is evident that many alterations, modifications, and variations will be apparent to those skilled in the art in light of the foregoing description without departing from the spirit or scope of the present disclosure. Accordingly, the present disclosure is intended to embrace all such alterations, modifications, and variations of the above detailed description.

All patents, test procedures, and other documents cited herein, including priority documents, are fully incorporated by reference to the extent such disclosure is not inconsistent with this invention and for all jurisdictions in which such incorporation is permitted.

When numerical lower limits and numerical upper limits are listed herein, ranges from any lower limit to any upper limit are contemplated.

What is claimed is:

1. An aqueous based copolymer emulsion composition, comprising:
i) from 1 to 60 wt. % of one or more copolymers comprising:
(a) one or more amine-derivatized alpha-methyl styrene (ADAMS) repeat units according to structure (I): 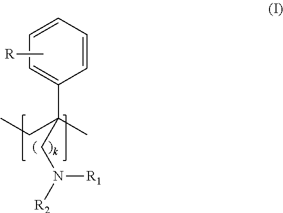
wherein:
k is an integer from 1 to 3;
R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof;
R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof, and
(b) one or more repeat units according to structures (II), (IIIₐ), (III_{b}), or combinations thereof 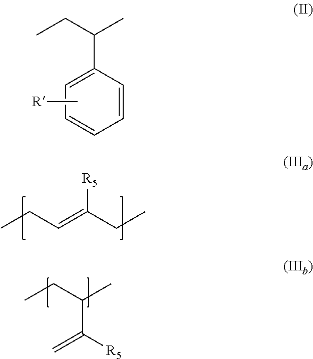
wherein:
R₅ is a hydrogen or methyl group;
R′ is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, and/or combinations thereof;
(ii) from 0.05 to 5.0 wt. % of one or more one or more surfactants selected from the group consisting of anionic surfactants, cationic surfactants, nonionic surfactants, amphoteric surfactants, and combinations thereof; and
(iii) the remainder of the composition comprising water.

2. The composition of claim 1, wherein the one or more anionic or cationic surfactants are selected from the group consisting of sodium dodecyl sulfonate, alkyl surfactants, silicone surfactants, fluorine surfactants, metal surfactants, and combinations thereof.

3. The composition of claim 1, wherein the one or more non-ionic surfactants are selected from the group consisting of silicone surfactants, fluorine surfactants, alkyl surfactants, polyether-based surfactants, and combinations thereof.

4. The composition of claim 1, wherein the particle size of the one or more copolymers in the emulsion composition is from 5 to 1000 nm.

5. The composition of claim 1, wherein the pH the composition is from 2 to 12.

6. The composition of claim 1, wherein the dynamic viscosity of the composition is from 2 to 2000 cP at 25 deg. C as measured by ASTM D5133.

7. The composition of claim 1 including from 4 to 20 wt. % of the one or more copolymers and from 80 to 96 wt % water.

8. The composition of claim 1, wherein k=2.

9. The composition of claim 8, wherein the one or more ADAMS repeat units according to structure (I) comprise the reacted form of 1-dimethylamino-3-phenylbut-3-ene, 1-diethylamino-3-phenylbut-3-ene, 1-di-n-propylamino-3-phenylbut-3-ene, 1-diisopropylamino-3-phenylbut-3-ene, 1-di-2-propenylamino-3-phenylbut-3-ene, 1-di-n-butylamino-3-phenylbut-3-ene, 1-di-sec-butylamino-3-phenylbut-3-ene, 1-diisobutylamino-3-phenylbut-3-ene, 1-di-tert-butylamino-3-phenylbut-3-ene, 1-cyclohexylmethylamino-3-phenylbut-3-ene, 1-dicyclohexylamino-3-phenylbut-3-ene, 1-di-(2-ethylhexyl)amino-3-phenylbut-3-ene, 1-di-(methoxyethyl)amino-3-phenylbut-3-ene, 1-di-(ethoxyethyl)amino-3-phenylbut-3-ene, 1-di-(phenoxyethyl)amino-3-phenylbut-3-ene, 1-di-(methylthioethyl)amino-3-phenylbut-3-ene, 1-di-(ethylthioethyl)amino-3-phenylbut-3-ene, 1-benzylmethylamino-3-phenylbut-3-ene, 1-dibenzylamino-3-phenylbut-3-ene, 1-benzylphenylamino-3-phenylbut-3-ene, 1-diphenylamino-3-phenylbut-3-ene, 1-dipyridylamino-3-phenylbut-3-ene, 1-phenylmethylamino-3-phenylbut-3-ene, 1-phenylmethoxyethylamino-3-phenylbut-3-ene, 1-benzylmethoxyethylamino-3-phenylbut-3-ene, 1-(N-morpholinyl)-3-phenylbut-3-ene, 1-(N-thiomorpholinyl)-3-phenylbut-3-ene, 1-(N-piperidinyl)-3-phenylbut-3-ene, 1-(N-piperazinyl)-3-phenylbut-3-ene, 1-(N-diazepanyl)-3-phenylbut-3-ene, 1-(N-pyrrolidinyl)-3-phenylbut-3-ene, 1-(N-pyrrolyl)-3-phenylbut-3-ene, 1-(1,2,3,4-tetrahydro-1-quinolinyl)-3-phenylbut-3-ene, 1-(1,2,3,4-tetrahydro-2-isoquinolinyl)-3-phenylbut-3-ene, 1-(N-indolinyl)-3-phenylbut-3-ene, 1-(N-indolyl)-3-phenylbut-3-ene, 1-(N-carbazolyl)-3-phenylbut-3-ene, 1-(N-phenothiazinyl)-3-phenylbut-3-ene, 1-(N-phenothiazinyl-S-oxide)-3-phenylbut-3-ene, 1-(N-phenothiazinyl-S,S-dioxide)-3-phenylbut-3-ene, 1-(N-phenoxazinyl)-3-phenylbut-3-ene, 1-(4-methyl-1-piperazinyl)-3-phenylbut-3-ene, 1-(5-methyl-2,5-diazabicyclo[2.2.1]heptan-2-yl)-3-phenylbut-3-ene, 1-(5-methyl-2,5-diazabicyclo[2.2.2]octan-2-yl)-3-phenylbut-3-ene, 1-(4-cyclopentyl-1-piperazinyl)-3-phenylbut-3-ene, 1-(4-cyclopentadienyl-1-piperazinyl)-3-phenylbut-3-ene, 1-(4-phenyl-1-piperazinyl)-3-phenylbut-3-ene, 1-(4-(thiazolyl)-1-piperazinyl)-3-phenylbut-3-ene, 1-(4-(thiadiazolyl)-1-piperazinyl)-3-phenylbut-3-ene, 1-(4-(triazolyl)-1-piperazinyl)-3-phenylbut-3-ene, 1-(4-(1,2,3-benzotriazolyl)-1-piperazinyl)-3-phenylbut-3-ene, 1-(N′-methyl-N-diazepanyl)-3-phenylbut-3-ene, or a combination thereof.

10. The composition of claim 1, wherein the one or more repeat units according to structure (II) comprise the reacted form of styrene, and the one or more repeat units according to structures (IIIₐ) and (III_{b}) comprise reacted forms of isoprene, 1,3-butadiene, or a combination thereof.

11. The composition of claim 1, wherein the copolymer further comprises:
an alkyl residue from a monofunctional alkyl lithium, alkyl sodium, and/or alkyl potassium initiator present at one or more termini of the polymer backbone;
or
an alkyl residue from a difunctional alkyl lithium, alkyl sodium, and/or alkyl potassium initiator at about a center of the polymer backbone.

12. The composition of claim 11, wherein the alkyl residues from the monofunctional initiators comprise methyl, ethyl, n-propyl, isopropyl, n-butyl, iso-butyl, sec-butyl, tert-butyl, n-amyl, iso-amyl, sec-amyl, tert-amyl, hexyl groups, or combinations thereof,
or
wherein the alkyl residues from difunctional initiators comprise propyl, butyl, pentyl, hexyl, 1,4-diphenylbutyl groups, or combinations thereof.

13. The composition of claim 1, wherein the copolymer is partially or substantially hydrogenated.

14. The composition of claim 1, wherein the one or more repeat units of structure (I) are interspersed within at least one polymer block comprising the one or more repeat units of structures (II), (IIIₐ), (III_{b}), or combinations thereof.

15. The composition of claim 1, wherein the one or more repeat units of structure (I) partially or substantially alternate with the one or more repeat units of structures (II), (IIIₐ), (III_{b}), or combinations thereof, thereby forming one or more repeat units corresponding to structures (IV), (Vₐ), (V_{b}), or combinations thereof:

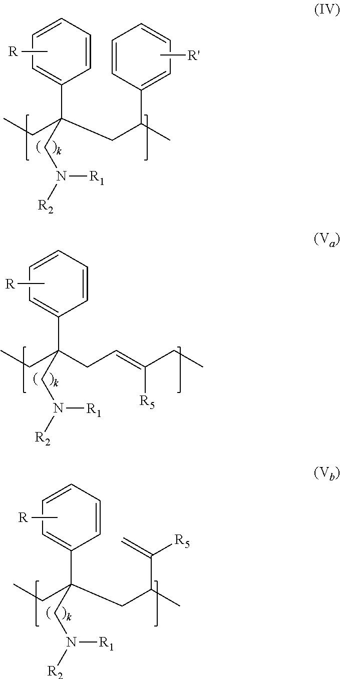

16. The composition of claim 1, wherein the copolymer comprises one or more polymer blocks comprising one or more repeat units of structures (II), (IIIₐ), (III_{b}), or combinations thereof, and not including one or more repeat units according to structure (I).

17. The composition of claim 16, wherein the one or more polymer blocks of the copolymer form a distributed polymer architecture, a diblock, a triblock, a tetrablock, a pentablock, a hexablock, a star polymer architecture, or combinations thereof.

18. The composition of claim 1, wherein an amino group in one or more repeat units of structure (I) are protonated or alkylated to their corresponding ammonium salt.

19. The composition of claim 18, wherein the protonated or alkylated ammonium salt comprises a chloride, bromide, iodide, alkyl or aryl sulfonate, sulfate, phosphate, formate, acetate, propionate, butyrate, benzoate, triflate, nitrate counterion, or a combination thereof.

20. The composition of claim 1, wherein the one or more copolymers have a number average molecular weight of from 1,000 daltons to 5,000,000 daltons.

21. An aqueous based copolymer emulsion composition comprising:
i) from 1 to 60 wt. % of one or more copolymers comprising:
(a) the reaction product of one or more monomers according to structure (VI) 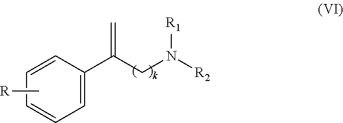
wherein:
k is an integer from 1 to 3;
R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof;
R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof, and
(b) the reaction product of one or more monomers according to structures (VII), (VIII), or combinations thereof 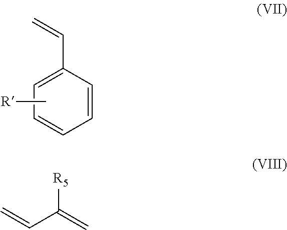
wherein:
R₅ is a hydrogen or methyl group;
R′ is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, and/or combinations thereof;
(ii) from 0.05 to 5.0 wt. % of one or more surfactants selected from the group consisting of anionic surfactants, cationic surfactants, nonionic surfactants, amphoteric surfactants, and combinations thereof, and
(iii) the remainder of the composition comprising water.

22. The composition of claim 21, wherein the one or more anionic or surfactants are selected from the group consisting of sodium dodecyl sulfonate, alkyl surfactants, silicone surfactants, fluorine surfactants, metal surfactants, and combinations thereof.

23. The composition of claim 21, wherein the one or more non-ionic surfactants are selected from the group consisting of silicone surfactants, fluorine surfactants, alkyl surfactants, polyether-based surfactants, and combinations thereof.

24. The composition of claim 21, wherein the particle size of the one or more copolymers is from 5 to 1000 nm.

25. The composition of claim 21, wherein the pH the composition is from 2 to 12.

26. The composition of claim 21, wherein the dynamic viscosity of the composition is from 2 to 2000 cP at 25 deg. C as measured by ASTM D5133.

27. The composition of claim 21 including from 4 to 20 wt. % of the one or more copolymers and from 80 to 96 wt % water.

28. The composition of claim 21, wherein the one or more copolymers have a number average molecular weight of from 1,000 daltons to 5,000,000 daltons.

29. A method of using an aqueous based copolymer emulsion composition comprising:
providing the composition according to claim 1, or an additive mixture including the composition according to claim 1, and
using the composition or the additive mixture including the one or more copolymers in an application selected from the group consisting of a secondary metal ion battery additive, a plastic additive, a drag reducing agent, a magneto-rheological fluid, an electro-chlorination additive, an industrial coating additive, an adhesive additive, an asphaltene and wax inhibitor, a refinery anti-foulant, an industrial or household surfactant, an agrochemical additive, a ceramic capacitor or indictor additive, an emulsion explosive additive, an anti-microbial coating, a crude transportation and refining additive, and a carbon-capture additive.

30. A method of making an aqueous based copolymer emulsion composition comprising the steps of:
i) providing one or more copolymers comprising:
(a) one or more amine-derivatized alpha-methyl styrene (ADAMS) repeat units according to structure (I): 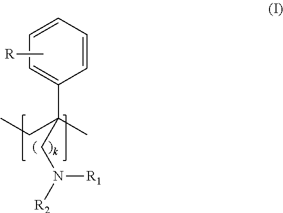
wherein:
k is an integer from 1 to 3;
R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof;
R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof, and
(b) one or more repeat units according to structures (II), (IIIₐ), (III_{b}), or combinations thereof 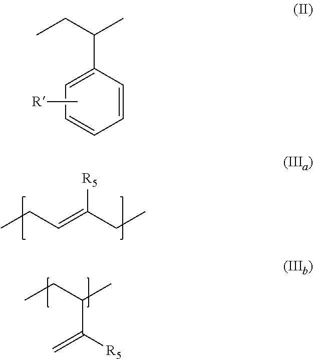
wherein:
R₅ is a hydrogen or methyl group;
R′ is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, and/or combinations thereof;
ii) dissolving the one or more copolymers into one or more organic solvents to form one or more dissolved copolymers;
iii) providing an aqueous surfactant solution including one or more surfactants selected from the group consisting of anionic surfactants, cationic surfactants, nonionic surfactants, amphoteric surfactants, and combinations thereof;
iv) combining and mixing the one or more dissolved copolymers and the aqueous surfactant solution;
v) further mixing the combined one or more dissolved copolymers and aqueous surfactant solution to form an emulsified mixture; and
vi) removing the one or more organic solvents from the emulsified mixture to form the aqueous based copolymer emulsion composition.

31. The method of claim 30, wherein the one or more organic solvents are selected from the group consisting of cyclohexane, tetrahydrofuran, dichloromethane, toluene, benzene, xylene, heptane, isooctane, and combinations thereof.

32. The method of claim 30, wherein the one or more anionic or cationic surfactants are selected from the group consisting of sodium dodecyl sulfonate, alkyl surfactants, silicone surfactants, fluorine surfactants, metal surfactants, and combinations thereof.

33. The method of claim 30, wherein the one or more non-ionic surfactants are selected from the group consisting of silicone surfactants, fluorine surfactants, alkyl surfactants, polyether-based surfactants, and combinations thereof.

34. The method of claim 30, wherein the mixing step in v) is via probe sonication, high shear mixing, or combinations thereof.

35. The method of claim 30, wherein the aqueous based copolymer emulsion composition includes from 1 to 60 wt. % of one or more copolymers; from 0.05 to 5.0 wt. % of the one or more one or more surfactants selected from the group consisting of anionic surfactants, cationic surfactants, nonionic surfactants, amphoteric surfactants, and combinations thereof, and the remainder of the composition comprising water.

36. A method of making an aqueous based copolymer emulsion composition comprising the steps of:
i) providing one or more copolymers comprising:
(a) the reaction product of one or more monomers according to structure (I) 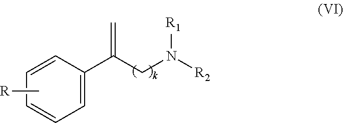
wherein:
k is an integer from 1 to 3;
R₁ and R₂ are each independently a hydrocarbyl group or a hydrocarbonaceous group having 1 to 4 additional heteroatoms selected from the group consisting of O, N, S, P, Se, and combinations thereof, or wherein R₁ and R₂ are connected to form a moiety containing at least one 5- to 12-membered ring, from 3 to 28 carbons, and optionally 1 to 6 additional heteroatoms selected from the group consisting of O, N, S, P, Se, and combinations thereof;
R is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, a C₁-C₆ hydrocarbyl group containing 1 to 4 additional heteroatoms selected from the group consisting of O, N, S, P, Se, and combinations thereof, and
(b) the reaction product of one or more monomers according to structures (VII), (VIII), or combinations thereof 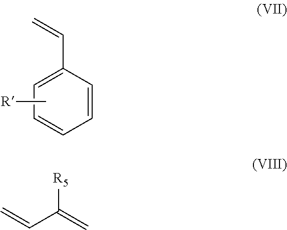
wherein:
R₅ is a hydrogen or methyl group;
R′ is hydrogen, a phenyl ring co-attached at two neighboring ring carbon positions with the phenyl ring shown so as to form a naphthalene assembly, a phenyl group attached at a single carbon of the phenyl ring shown, a C₁-C₄ hydrocarbyl group, and/or combinations thereof;
ii) dissolving the one or more copolymers into one or more organic solvents to form one or more dissolved copolymers;
iii) providing an aqueous surfactant solution including one or more surfactants selected from the group consisting of anionic surfactants, cationic surfactants, nonionic surfactants, amphoteric surfactants, and combinations thereof;
iv) combining and mixing the one or more dissolved copolymers and the aqueous surfactant solution;
v) further mixing the combined one or more dissolved copolymers and aqueous surfactant solution to form an emulsified mixture; and
vi) removing the one or more organic solvents from the emulsified mixture to form the aqueous based copolymer emulsion composition.

37. The method of claim 36, wherein the one or more organic solvents are selected from the group consisting of cyclohexane, tetrahydrofuran, dichloromethane, toluene, benzene, xylene, heptane, isooctane, and combinations thereof.

38. The method of claim 36, wherein the one or more anionic or cationic surfactants are selected from the group consisting of sodium dodecyl sulfonate, alkyl surfactants, silicone surfactants, fluorine surfactants, metal surfactants, and combinations thereof.

39. The method of claim 36, wherein the one or more non-ionic surfactants are selected from the group consisting of silicone surfactants, fluorine surfactants, alkyl surfactants, polyether-based surfactants, and combinations thereof.

40. The method of claim 36, wherein the mixing step in v) is via probe sonication, high shear mixing, or combinations thereof.

41. The method of claim 36, wherein the aqueous based copolymer emulsion composition includes from 1 to 60 wt. % of one or more copolymers; from 0.05 to 5.0 wt. % of the one or more ionic surfactants, one or more non-ionic surfactants, or a combination thereof; and the remainder of the composition comprising water.
